(19) United States
(12) Patent Application Publication
(10) Pub. No.: US 2025/0299157 A1
(43) Pub. Date: Sep. 25, 2025

(54) ITEM INVENTORY DETERMINATION USING CONFIDENCE-BASED RADIO FREQUENCY IDENTIFICATION RANGING

(71) Applicant: QUALCOMM Incorporated, San Diego, CA (US)

(72) Inventors: Paul Dominic HISCOCK, Cambridge (GB); Joseph Patrick BURKE, Carlsbad, CA (US); Sumit AGRAWAL, San Diego, CA (US)

(21) Appl. No.: 19/084,673

(22) Filed: Mar. 19, 2025

Related U.S. Application Data
(60) Provisional application No. 63/567,876, filed on Mar. 20, 2024.

(51) Int. Cl. G06Q 10/087; G06K 19/07

(52) U.S. Cl. CPC G06Q 10/087; G06K 19/0723

(57) ABSTRACT

Systems and techniques are provided for wireless communications. For example, a process can include receiving, by a wireless communication device, a plurality of backscatter signals from a Radio Frequency Identification (RFID) tag, wherein each backscatter signal comprises a reflection of a respective RFID ranging signal. An estimated distance from the wireless communication device to the RFID tag can be determined, using a respective RFID measurement associated with each backscatter signal of the plurality of backscatter signals. The estimated distance can be compared to a configured threshold distance that is indicative of a volume associated with a container. A container content item inventory indicative of one or more items included within the volume associated with the container can be determined, wherein an item associated with the RFID tag is included in the container content item inventory based on the estimated distance being less than or equal to the configured threshold distance.

### CROSS-REFERENCE TO RELATED APPLICATIONS

This application is a continuation of U.S. Patent Application 63/567,876, filed Mar. 20, 2024, which is hereby incorporated by referenced in its entirety and for all purposes.

### FIELD OF THE DISCLOSURE

The present disclosure generally relates to wireless communications. For example, aspects of the present disclosure relate to item and/or inventory tracking based on radio frequency identification (RFID) tag information.

### BACKGROUND

Short range wireless communication enables wireless communication over relatively short distances (e.g., within thirty meters). For example, Radio Frequency Identification (RFID) systems can be used to perform short range wireless communication based on the wireless transfer of data between a reader (e.g., RFID reader device) and a tag or transponder (e.g., RFID tag). RFID systems can be used for identification, tracking, data storage, etc. For example, RFID systems can be used to identify and/or track various items, such as warehouse boxes or consumer products.

An RFID tag may be attached to an item to be tracked and may include data storage and an antenna. The data storage stores information corresponding to the associated item, such as a product name, a serial number, product information, a manufacturer, etc. The antenna enables the RFID tag to be read by an RFID reader, which transmits an interrogating signal to one or more RFID tags within communication range. RFID tags can be passive, active, semi-passive or semi-active. Passive RFID tags utilize the interrogating signal from an RFID reader to power a transmission by or from the RFID tag. Active, semi-passive and semi-active RFID tags can include a power source or battery, which can be used to power a transmission by or from the RFID tag.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a method of wireless communications is provided, the method comprising: receiving, by a wireless communication device, a plurality of backscatter signals from a Radio Frequency Identification (RFID) tag, wherein each backscatter signal comprises a reflection of a respective RFID ranging signal; determining an estimated distance from the wireless communication device to the RFID tag, wherein the estimated distance is determined using a respective RFID measurement associated with each backscatter signal of the plurality of backscatter signals; comparing the estimated distance to a configured threshold distance, wherein the configured threshold distance is indicative of a volume associated with a container; and determining a container content item inventory indicative of one or more items included within the volume associated with the container, wherein an item associated with the RFID tag is included in the container content item inventory based on the estimated distance being less than or equal to the configured threshold distance.

In another example, an apparatus for wireless communications is provided. The apparatus includes at least one memory and at least one processor coupled to the at least one memory and configured to: receive a plurality of backscatter signals from a Radio Frequency Identification (RFID) tag, wherein each backscatter signal comprises a reflection of a respective RFID ranging signal; determine an estimated distance from the wireless communication device to the RFID tag, wherein the estimated distance is determined using a respective RFID measurement associated with each backscatter signal of the plurality of backscatter signals; compare the estimated distance to a configured threshold distance, wherein the configured threshold distance is indicative of a volume associated with a container; and determine a container content item inventory indicative of one or more items included within the volume associated with the container, wherein an item associated with the RFID tag is included in the container content item inventory based on the estimated distance being less than or equal to the configured threshold distance.

In another example, a non-transitory computer-readable medium is provided that includes instructions that, when executed by at least one processor, cause the at least one processor to: receive a plurality of backscatter signals from a Radio Frequency Identification (RFID) tag, wherein each backscatter signal comprises a reflection of a respective RFID ranging signal; determine an estimated distance from the wireless communication device to the RFID tag, wherein the estimated distance is determined using a respective RFID measurement associated with each backscatter signal of the plurality of backscatter signals; compare the estimated distance to a configured threshold distance, wherein the configured threshold distance is indicative of a volume associated with a container; and determine a container content item inventory indicative of one or more items included within the volume associated with the container, wherein an item associated with the RFID tag is included in the container content item inventory based on the estimated distance being less than or equal to the configured threshold distance.

In another example, an apparatus for wireless communications is provided. The apparatus includes: means for receiving, by a wireless communication device, a plurality of backscatter signals from a Radio Frequency Identification (RFID) tag, wherein each backscatter signal comprises a reflection of a respective RFID ranging signal; means for determining an estimated distance from the wireless communication device to the RFID tag, wherein the estimated distance is determined using a respective RFID measurement associated with each backscatter signal of the plurality of backscatter signals; means for comparing the estimated distance to a configured threshold distance, wherein the configured threshold distance is indicative of a volume associated with a container; and means for determining a container content item inventory indicative of one or more items included within the volume associated with the container, wherein an item associated with the RFID tag is included in the container content item inventory based on the estimated distance being less than or equal to the configured threshold distance.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating example components of a device, in accordance with some examples;

FIG. 3 is a diagram illustrating an example of an RFID system, in accordance with some examples;

FIG. 4A is a diagram illustrating an example of an RFID system that can be used for phase-based ranging (PBR) and/or PBR-based distance estimation, in accordance with some examples;

FIG. 4B is a diagram illustrating an example of PBR-based distance estimation using a plurality of RFID phase measurements, in accordance with some examples;

FIG. 5 is a diagram illustrating an example of an RFID system that can be used for selective RFID tag reading and/or determining item inventory information, in accordance with some examples;

FIG. 6 is a diagram illustrating an example of an RFID system that includes one or more reference RFID tags that can be used for selective RFID tag reading and/or determining item inventory information, in accordance with some examples;

FIG. 7 is a flowchart diagram illustrating an example of a process for wireless communications, in accordance with some examples; and

FIG. 8 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Radio Frequency Identification (RFID) systems can be used for short range wireless communication between a reader device (e.g., RFID reader) and one or more tags or transponders (e.g., RFID tags). An RFID reader may also be referred to as an “RFID interrogator,” and “RFID scanner,” and/or an “energizer.” RFID systems can be used to identify and/or track various items that are associated with one or more RFID tags (e.g., various items to which one or more RFID tags are attached). RFID systems can read and/or write information to and/or from (respectively) RFID tags, based on respective wireless communications between an RFID reader and the RFID tags.

For example, an RFID reader (e.g., energizer) can be used to interrogate one or more RFID tags to obtain information of the nearby items that are within communication range of the RFID reader and the interrogation signal. The RFID reader (e.g., energizer) can transmit a radio frequency (RF) signal to perform the energizing and interrogating of the RFID tags. An RFID tag that receives the interrogating RF wave can respond by backscattering (e.g., reflecting back) and/or transmitting another RF wave. An RFID tag may generate the responsive RF wave originally (e.g., in examples where the RFID tag is an active or semi-active tag). An RFID tag may generate the responsive RF wave passively, for instance by reflecting back a portion of the interrogating RFID wave using a backscatter process (e.g., in examples where the RFID tag is a passive tag).

In some examples (e.g., such as in product-related and/or service-related industries, etc.), RFID systems can be used to track objects that are being processed, inventoried, shipped, handled, etc. For example, an RFID tag can be attached to an individual item (e.g., to the packaging of an individual item, etc.) to provide tracking and identification of the individual item. In some examples, an RFID tag can be attached to a collection or group of individual items (e.g., to a pallet of same or similar items being shipped to a store or distribution center, etc.).

An RFID tag attached to a respective item, or attached to a group of items, may store corresponding information thereof. For example, an RFID tag can include a data storage element that stores information corresponding to the item(s) to which the RFID is attached and associated. For instance, RFID tag information can include one or more of a product name, a serial number, product information, a manufacturer, etc. In some examples, the RFID tag can store identification information that is directly indicative of a tagged item, product, object, etc. For instance, an RFID tag can store identification information such as a unique product serial number, etc. In some examples, the RFID tag does not store product or item identification information directly, and stores a unique RFID tag serial number or identification number which may be externally mapped to various item identification information such as product serial numbers, product names, product SKUs, etc.

An RFID reader (e.g., energizer) can transmit an RF signal configured to cause the RFID tags to transmit at least a portion of their respective identification information. The RFID reader can receive (e.g., scan) the identification information transmitted by the one or more RFID tags energized by the RFID reader, and can use the identification information to determine the tagged items or products that are nearby to the RFID reader.

In some examples, RFID tags can store item identification information that utilizes various granularity levels for tracking and management of the RFID tagged items. For example, RFID tags can be used to track item types or models by using different RFID tags (e.g., unique identifiers) per item type or item model, with RFID identifier reuse across individual tagged items that are of the same type or model. For instance, the RFID tags used for each item of a particular type may store the same product identifier, and can be used to decrement an inventory count for the particular item whenever a tag is scanned and removed from the shelf, from the store, etc.

In another example, RFID tags can be used to track and identify individual items, based on using a corresponding RFID tag and unique identifier for each individual item of a plurality of RFID-tagged items that are registered with the RFID system. In some examples, individual and unique item identifiers can be implemented based on using individual and unique RFID tag serial numbers or identifiers, which may be mapped separately to a corresponding individual item. In some examples, individual and unique item identifiers can be implemented based on using a product type identifier combined with a unique identifier within that product type. For instance, items can be tagged with their corresponding product SKU and a unique identifier of each item within the corresponding product SKU. In some cases, the unique RFID tag identifiers can be mapped in one or more databases to additional information associated with an item, such as manufacturing data, batch number, specific store location, etc.

RFID systems can be used in a retail environment for purposes such as inventory tracking (e.g., determining when items are removed from shelves, which particular items are removed from shelves and the quantity thereof, etc.). RFID systems can also be used in a retail environment for determining the contents of a container (e.g., a basket, box, or other type of container of a consumer or person shopping for items), for instance based on reading the RFID tags of items as they are placed in the container, reading the RFID tags of the items once they are within the container, reading the RFID tags of the items during the checkout process or as the final collection of items is removed from the container, etc. As used herein, a “container” can refer to any receptacle or volume within which items are placed for temporary storage and/or transport (e.g., prior to purchase of the items). For example, a container can include various implementations, such as a basket (e.g., a handheld basket), a cart or trolley, a bag or satchel, a box, etc. A “container” or “container contents” may also refer to the hand carry of one or more items carried by a person. In some aspects, a container or container volume may refer to a car, vehicle, automobile, etc., having a receptable or volume within which items are placed for temporary storage and/or transport (e.g., including for transportation to and/or from a retail environment or other point of sale of the RFID-tagged items, etc.).

RFID readers can be configured to read hundreds of RFID tags per second, based on the respective RFID tags responding to an interrogation signal from the RFID reader using a corresponding time slot determined for the respective RFID tag. The time slot used by an RFID tag may be assigned by the RFID reader, or may be determined by the RFID tags. For example, RFID tags can respond to an interrogation signal based on randomly choosing a time slot within a configured time window for response. In some cases, an anti-collision algorithm can be used to divide a time window into a plurality of discrete time slots for RFID tags responses, within which each RFID tag may randomly choose or be assigned a particular time slot. Each RFID tag transmits its identification information back to the reader in the corresponding or allocated time slot for the RFID tag. Restricting each RFID tag to a particular time slot reduces the changes of a collision occurring when two or more RFID tags attempt to transmit during the same time slot. If a collision occurs, the multiple RFID tags attempting to transmit during the same time slot are not successfully read by the RFID reader, and may be configured to select new time slots and retransmit.

RFID systems may commonly be implemented without the capability to perform selective reporting. Selective reporting can be associated with an RFID reader that reports only information associated with RFID tags of interest, where the RFID tags of interest are a subset within a larger plurality of RFID tag reflections that are read by the RFID reader. For example, a non-selective RFID reader will report the reflected information read for any RFID tag that is within range to respond to the interrogation signal(s) from the reader. A selective RFID reader can perform selective reporting to filter the reflected information received from a plurality of RFID tags and report only the corresponding information associated with a subset of interest. However, the selective reporting of RFID tag identification information does not suppress RFID tags that are not of interest (e.g., not included in the subset of interest) from responding to the interrogation signal (e.g., the RFID tags not of interest will still respond and consume a time slot). Additionally, in some examples it can be difficult or impossible to determine in advance which RFID tags belong to the subset of interest and which RFID tags do not belong to the subset of interest. For example, in use cases such as a determination of contents in a container of a person shopping (e.g., identifying the products placed into a shopper's basket in a store), a primary task for which the RFID system is utilized may be to determine the subset of interest comprising RFID tags of items selected for purchase by the person and placed into the container.

In some cases, an RFID system can utilize one or more RFID readers (e.g., energizers) with antenna configurations that are adjusted to limit the reading range and/or reading zone. For example, an RFID reader can be configured with a reading zone that corresponds to an angular section of an omnidirectional or 360° reading zone. The selective reading of RFID tags based on antenna configurations of an RFID reader can be challenging when the spatial relationship between the RFID reader(s) and the RFID tag(s) is unknown and/or changing. For example, in a container content determination example, the relative spatial positions of the RFID reader and the RFID tags in a container (e.g., a shopper's basket) can vary, and/or the relative spatial positions of the RFID reader and the RFID tags of items in an environment (e.g., items located on shelves in a store) can vary.

In some aspects, selective RFID tag reading can be performed based on measuring the respective signal strength of reply transmissions received by an RFID reader from nearby RFID tags (e.g., the nearby RFID tags receiving an energizing or interrogation signal from the RFID reader). In one illustrative example, the systems and techniques can be configured to determine a respective Received Signal Strength Indicator (RSSI) value for each reflected signal received from an RFID tag (e.g., passive RFID tag) in response to an energizing signal used by the RFID reader to interrogate and scan nearby tags. The RSSI value can be indicative of the power level of the reflected signal received by an antenna of the RFID reader, where a larger RSSI value corresponds to a stronger reflected signal. In some cases, RFID ranging or distance estimation between the RFID reader and a plurality of RFID tags can be implemented based on the respective RSSI value determined for the reflected signal(s) from each RFID tag, where a larger RSSI value is associated with a shorter distance between the RFID reader and the corresponding RFID tag. For example, based on a placement of the RFID reader (e.g., energizer) on, within, or nearby to the container, one or more signal strength thresholds can be used to filter the RFID tag identification information of the contents in the container from the background noise of unwanted RFID tags corresponding to items in the environment (e.g., items on the shelves) or otherwise not within the container contents. In some aspects, an RFID system can be used to determine the contents of the container (e.g., RFID tags within the container volume) and/or can be used to determine the contents outside of the container (e.g., RFID tags not within the container volume). In some cases, the RFID reader (e.g., energizer) can be integrated with the container, can be configured as a smartphone or UE (e.g., of the person, such as a shopper), etc. Based on determining that the RSSI of the reflected signal from a respective RFID tag is greater than a configured (e.g., pre-determined) threshold, the item corresponding to the identification information of the respective RFID tag can be included in the contents of the container.

The location accuracy of RSSI-based location or ranging estimates can be relatively low, for example on the order of 5-10 meter (m) accuracy. In a retail environment (or other densely populated RFID environment), a 5-10 m location and ranging accuracy can be insufficient to perform reliable and accurate inventory estimation for RFID tagged items. For example, a 5-10 m location and ranging accuracy may be insufficient for estimating the contents in a container (e.g., items in a shopping basket), as both the container contents and the surrounding shelves of RFID tagged products or items fall within the radius of error or uncertainty associated with the RSSI-based ranging estimate.

When the location and ranging accuracy of an RFID-based ranging estimate is larger than the area or volume of interest for the selective reading of RFID tags (e.g., such as when the location and ranging accuracy of an RFID-based ranging estimate is larger than the area or volume of a container, such as a shopper's basket), various RFID tagged items may incorrectly be included and/or excluded from the estimated item inventory of the contents in the container (also referred to herein as container content item inventory or basket content item inventory). For example, with a 5-10 m ranging accuracy for RSSI-based selective RFID reading, one or more items on nearby portions of the environment (e.g., nearby store shelves) or in other containers (e.g., other shoppers' baskets) may incorrectly be included in the estimated item inventory of a different person (e.g., a different shopper). In another example, one or more items that are located within contents in the container (e.g., basket item inventory) may incorrectly be excluded from the estimated item inventory for that person (e.g., the shopper using the container).

There is a need for systems and techniques that can be used to perform selective reading of RFID tags with improved accuracy, for example to determine contents in a container or item inventory associated with a user (e.g., to determine contents in container, such as a shopper's basket contents, to determine contents outside of or not within the container, etc.), without a priori information of a selected subset of RFID tags of interest. There is a further need for systems and techniques that can be used to perform selective reading of RFID tags to determine content in a container (e.g., the items placed within a shopper's basket in a store or retail environment) through the recording of collected items' RFID identification information. There is a need for systems and techniques that can be used to perform selective RFID tag reading for container content determination prior to checkout and/or without using spatial isolation between tags of interest and tags not of interest. For example, there is a need for selective RFID tag reading to track the evolution of contents in a container throughout a user or customer's progression through a store or retail environment, based on distinguishing between the RFID tags of collected items and the RFID tags of on-shelf items and other background noise (e.g., including tracking the evolution of contents in a container at one or more periodic time intervals, tracking the contents in the container in continuous time, and/or tracking the changes in the contents in the container in continuous time, etc.).

Systems, apparatuses, processes (also referred to as methods), and computer-readable media (collectively referred to as “systems and techniques”) are described herein that can be used to perform selective reading of RFID tags and RFID tag identification information corresponding to collected items in a container (e.g., in a shopper's basket, also referred to as “basket contents”) and/or items outside of (e.g., not within the volume of) the container. The systems and techniques can perform selective RFID tag reading without using configuration information that is indicative of a first subset of RFID tags that are of interest and/or that is indicative of a second subset of RFID tags that are not of interest. The systems and techniques can be used to obtain RFID tag identification information corresponding to contents in a container (e.g., a shopper's basket contents) based on a time series and/or location-based analysis of RFID tag identification information obtained from a plurality of RFID tags attached to products in an environment (e.g., in a store or retail environment).

In some aspects, the systems and techniques can use an RFID reader or other RFID scanner device to determine item inventory information corresponding to one or more RFID tagged items that are located within a configured volume around the RFID reader. In some cases, the RFID reader can be used to determine one or more RFID tagged items that are within a configured radius or range (e.g., distance) from the RFID reader. In some examples, items within a configured radius of or volume associated with the RFID reader can be the content in the container of a user (e.g., shopping basket contents of a user or shopper). For instance, items within the radius or volume can be identified as included in the contents of the container (e.g., in the basket contents), and items not within the radius or volume are identified as not included in the contents of the container. In some cases, the RFID reader or scanner device can be a smartphone, tablet computer, or other mobile computing device associated with the user. The mobile computing device can be removably placed within the container (e.g., shopping basket) or other volume of interest, and/or may be permanently or semi-permanently coupled to the container or other volume of interest.

In one illustrative example, one or more phase-based ranging (PBR) measurements can be performed between the RFID reader device and the RFID tags within the vicinity of the RFID reader device. The RFID tags within the vicinity of the RFID reader device can include RFID tags attached to items that are included in the container contents inventory and RFID tags attached to items that are not included in the container contents inventory. In some examples, the PBR measurements can be used to determine an estimated distance or range between the RFID reader device and the corresponding RFID tag associated with one or more PBR measurements. In some aspects, one or more RSSI or RSSI-based measurements can be performed between the RFID reader device and one or more RFID tags to determine an RSSI-based distance estimate. In some examples, the RFID reader can determine a distance estimate to various RFID tags using a combination of PBR measurements (e.g., corresponding to PBR-based distance estimation) and RSSI measurements (e.g., corresponding to RSSI-based distance estimation).

In one illustrative example, the systems and techniques can determine confidence information for each measurement and/or distance estimation between the RFID reader device and a particular RFID tag (e.g., for each RFID tag of a plurality of RFID tags within the vicinity of the RFID reader device, for each RFID tag of a plurality of RFID tags that transmit a reflected signal in response to an interrogation signal from the RFID reader device, etc.). In some aspects, a respective confidence information can be determined for each PBR measurement between the RFID reader and a respective RFID tag and/or for each RSSI measurement between the RFID reader and a respective RFID tag.

For example, the confidence information indicative of a probability distribution corresponding to the distance or range between the RFID reader and a respective RFID tag. In some cases, the confidence information can be indicative of a maximum estimated distance and a minimum estimated distance between the RFID reader and respective RFID tag. The confidence information may be indicative of corresponding probabilities of the distance between the RFID reader and respective RFID tag being less than, greater than, or equal to various values between the maximum and minimum estimated distances. In some cases, the confidence information can be indicative of corresponding probabilities of the distance between the RFID reader and respective RFID tag being inside of or outside of a configured range of distance values, where the configured range of distance values comprises a subset within (e.g., between) the maximum and minimum estimated distances.

In some aspects, the confidence information determined for the respective RFID tags can be compared to one or more configured thresholds (e.g., a threshold configured to a particular value). Based on the confidence information for one or more RFID tags being less than a configured threshold value, the RFID reader device can be moved or repositioned within the user's container (e.g., a shopping basket or other volume of interest for selective RFID tag reading), and the RFID measurements between the RFID reader and the surrounding RFID tags can be performed one or more additional times. In some aspects, the RFID reader can be moved within the container (e.g., the user's basket) and the RFID measurements (e.g., RFID ranging and distance estimation) performed to determine distance estimates between the RFID reader and the RFID tags within the vicinity, until a configured percentage of RFID distance estimates are associated with confidence information greater than or equal to a threshold value.

In some examples, one or more fixed reference tags can be used to improve the accuracy of the RFID distance estimation or ranging, and/or item inventory estimation for the contents of the container. For example, a fixed reference tag can be implemented as an RFID tag attached to a known location on or within the container (e.g., the shopper's basket or other volume of interest for selective RFID tag reading). In one illustrative example, a plurality of RFID tags can be used as fixed references for a calibration process performed by the RFID reader before the RFID ranging-based item inventory estimation of the contents in the container. For example, a respective fixed reference RFID tag can be attached to one or more (or all) of the four bottom interior corners and/or four top interior of a container (e.g., a shopper's basket). Calibration can be performed based on placing the RFID reader device (e.g., a smartphone, UE, or other mobile computing device associated with the user) within the container, and performing a respective RFID ranging measurement between the RFID reader and each one of the fixed reference RFID tags. For example, the RFID reader can perform calibration based on a respective RFID ranging measurement with one or more (or all) of a front bottom left reference RFID tag, a front bottom right reference RFID tag, a back bottom left reference RFID tag, a back bottom right reference RFID tag, a front upper left reference RFID tag, a front upper right reference RFID tag, a back upper left reference RFID tag, and/or a back upper right reference RFID tag, etc.

Based on the calibration RFID measurements from the RFID reader to the fixed reference RFID tags within the container volume, the RFID reader can determine its relative three-dimensional (3D) location within the container and/or relative to the known and fixed reference point locations for the respective RFID reference tags. From the relative 3D location of the RFID reader and/or the estimated distances from the RFID reader to the respective RFID reference tags, the systems and techniques can determine a calibration radius corresponding to the container volume, where RFID tags with an estimated distance greater than the calibration radius are identified as not included in the container content item inventory, and where RFID tags with an estimated distance less than or equal to the calibration radius are identified as included in the container content item inventory.

Further aspects of the systems and techniques will be described with reference to the figures.

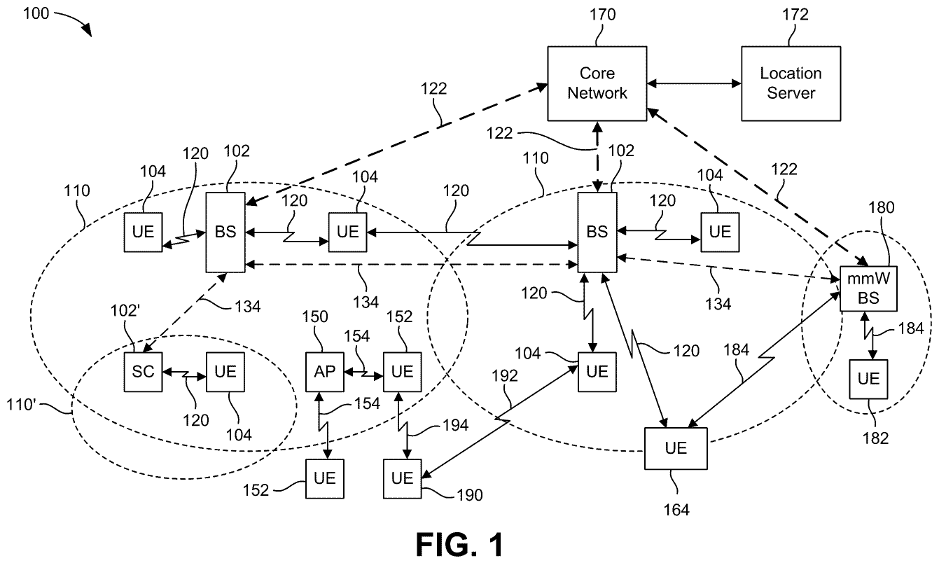

According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHZ), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

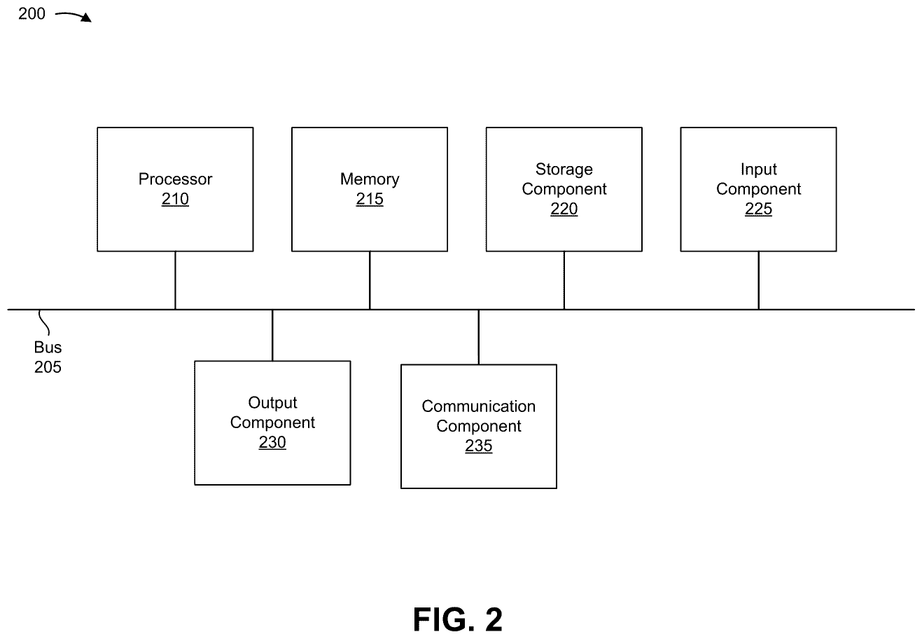

FIG. 2 is a diagram illustrating example components of a device 200, in accordance with the present disclosure. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

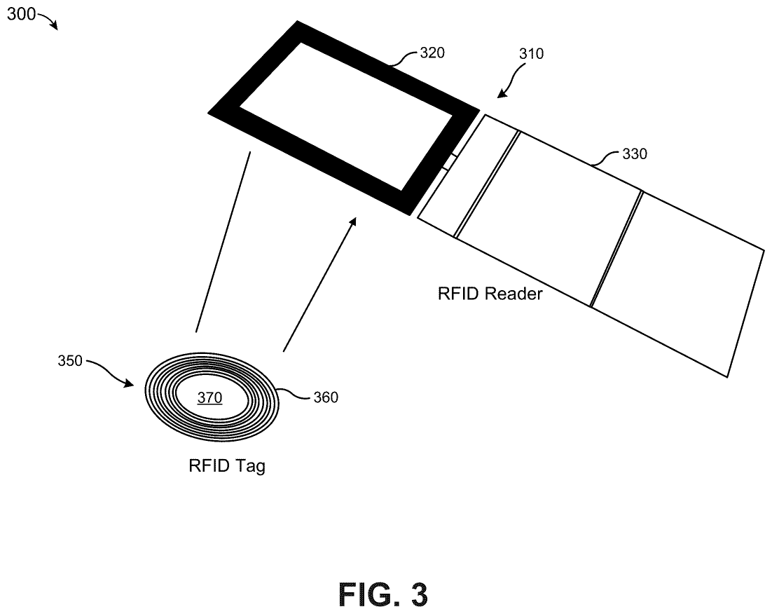

FIG. 3 is a diagram illustrating an example RFID system 300 that includes an RFID reader (e.g., energizer) 310 and an RFID tag 350. RFID reader 310 may also be referred to as an interrogator, a scanner, an energizer, etc. RFID tag 350 may also be referred to as an RFID label, an electronics label, etc.

RFID reader 310 includes an antenna 320 and an electronics unit 330. Antenna 320 radiates signals transmitted by RFID reader 310 and receives signals from RFID tags (e.g., such as the RFID tag 350) and/or other devices. Electronics unit 330 may include a transmitter and a receiver for reading RFID tags such as RFID tag 350. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags, and a second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 330 may include processing circuitry (e.g., a processor) to perform processing for data being transmitted and received by RFID reader 310.

RFID tag 350 includes an antenna 360 and a data storage element 370. Antenna 360 radiates signals transmitted by RFID tag 350 and receives signals from RFID reader 310 and/or other devices. For instance, RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag. In some examples, the RFID tag 350 may be a passive RFID tag having no battery. In this case, a magnetic field from a signal transmitted by RFID reader 310 (e.g., an energizing or interrogating signal from the RFID reader 310) may induce an electrical current in RFID tag 350, which may then operate based on the induced current. RFID tag 350 can radiate its signal in response to receiving a signal from RFID reader 310 or some other device.

The RFID tag 350 can use the data storage element 370 to store identification information corresponding to the RFID tag 350 and/or corresponding to an item associated with the RFID tag 350 (e.g., an item to which the RFID tag 350 is attached, etc.). For example, data storage element 370 can be used to store identification information using various granularity levels for tracking and management of an RFID tagged item. An RFID tag attached to a respective item, or attached to a group of items, may store corresponding information thereof. For example, the RFID tag 350 can be configured to store, using data storage element 370, identification information corresponding to the item(s) to which the RFID tag 350 is attached and associated. For instance, RFID tag information can include one or more of a product name, a serial number, product information, a manufacturer, etc. In some examples, the RFID tag 350 can store (e.g., using the data storage element 370) identification information that is directly indicative of a tagged item, product, object, etc. For instance, the RFID tag 350 can store identification information such as a unique product serial number, etc. In some examples, the RFID tag 350 does not store product or item identification information directly, and stores a unique RFID tag serial number or identification number corresponding to the RFID tag 350, which may be externally mapped to various item identification information such as product serial numbers, product names, product SKUs, etc.

Data storage element 370 can be configured to store identification information for RFID tag 350, e.g., in an electrically erasable programmable read-only memory (EEPROM). RFID tag 350 may also include an electronics unit that can process the received signal and generate the signals to be transmitted.

RFID tag 350 may be read as follows. RFID reader 310 may be placed or moved within close proximity to RFID tag 350. RFID reader 310 may radiate a first signal (which is also called an interrogation signal) via its antenna 320. The energy of the first signal may be coupled from RFID reader antenna 320 to RFID tag antenna 360 via magnetic coupling and/or other phenomena. RFID tag 350 may receive the first signal from RFID reader 310 via antenna 360 and, in response, may radiate a second signal (which is also referred to as a responding signal) comprising the information stored in data storage element 370. RFID reader 310 may receive the second signal from RFID tag 350 via antenna 320 and may process the received signal to obtain the information sent in the second signal.

RFID system 300 may be designed to operate at various frequencies and/or frequency ranges. For example, RFID system 300 can operate at 900 MHz, within a range of 860-960 MHz, etc., among various other example frequencies and/or frequency ranges of RFID operations. RFID reader 310 may have a specified maximum transmit power level, which may be imposed by the Federal Communication Commission (FCC) in the United Stated or other regulatory bodies in other countries. The specified maximum transmit power level of RFID reader 310 limits the distance at which RFID tag 350 can be read by RFID reader 310.

As noted previously, the systems and techniques described herein can be used to perform selective reading of RFID tags and RFID tag identification information corresponding to collected items of a container, such as a shopper's basket (e.g., also referred to as “basket contents”). The systems and techniques can perform selective RFID tag reading to determine, generate, and/or update item inventory information corresponding to the selectively read RFID tags. In one illustrative example, the item inventory information of selectively read RFID tags can correspond to RFID tagged items that are within the container (e.g., the shopper's basket).

For illustrative purposes, examples are described herein using a shopper's “basket” as an illustrative example of a container. However, the systems and techniques also apply to any other type of container. A shopper's “basket” (as an example of a container) can refer to any receptacle or volume within which items are placed for temporary storage and/or transport (e.g., prior to purchase or other use). For example, a shopper's “basket” can include various implementations, such as a handheld-basket, a cart or trolley, a bag or satchel, etc. A shopper's “basket” or “basket contents” may also refer to the hand carry of one or more items by a shopper.

In some aspects, RFID measurements can be performed with a plurality of RFID tags (e.g., RFID tags attached to corresponding items, also referred to as “RFID tagged items”). The RFID measurements can include phase-based ranging (PBR) measurements, Received Signal Strength Indicator (RSSI) measurements, and/or various combinations thereof.

PBR measurements can be performed between an RFID reader device and an RFID tag, where the RFID reader device is configured to transmit an energizing or interrogating signal and the RFID tag is configured to reflect the interrogating signal as a backscatter signal (e.g., also referred to as a “reflected signal” and/or “reply signal”).

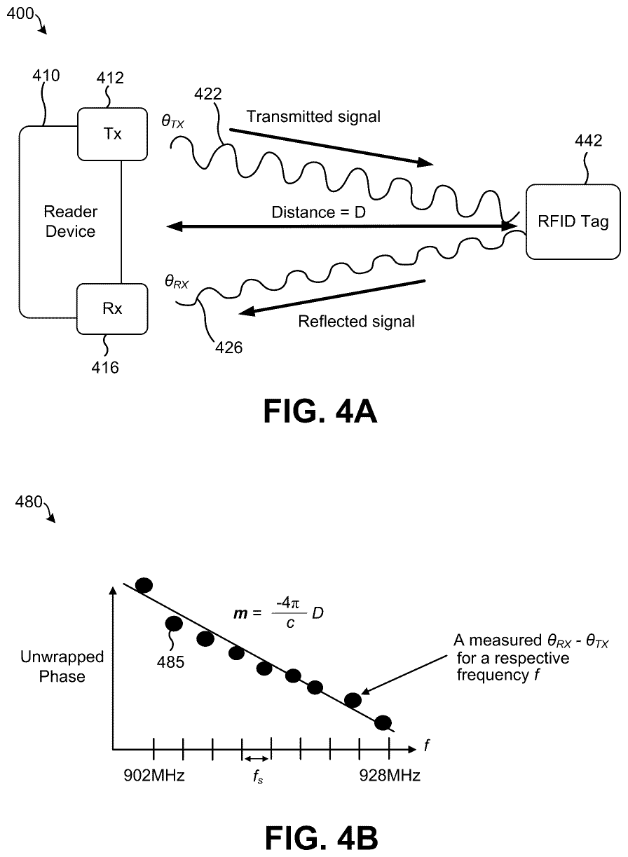

For example, FIG. 4A is a diagram illustrating an example of an RFID system 400 that can be used for phase-based ranging (PBR) and/or PBR-based distance estimation, in accordance with some examples. An RFID reader device 410 can include a transmitter (Tx) 412 and a receiver (Rx) 416, configured to transmit and receive RF signals, respectively. The RFID reader device 410 can use the transmitter 412 to transmit a transmitted signal 422 to an RFID tag 442. The transmitted signal 422 may be associated with a transmitted phase θ_{TX}. In some cases, the transmitted signal 422 may be a modulated signal, or may be an unmodulated signal (e.g., a carrier signal).

The transmitted signal 422, with phase θ_{TX}, propagates a distance D between the reader device 410 and the RFID tag 442, where the distance D is the separation distance or range between the reader device 410 and the RFID tag 442 (e.g., and where the distance D is relatively small such that propagation time does not have a significant effect on the measurement(s)). The RFID tag 442 can be a backscatter RFID tag configured to backscatter (e.g., reflect) an incident signal. For example, the RFID tag 442 can backscatter (e.g., reflect) the transmitted signal 422 as a reflected signal 426. The reflected signal can be associated with a phase θ_{RX} that may be different from the transmitted phase θ_{TX}. The reflected signal 426 is transmitted back to the RFID reader device 410, and is received by the receiver 416 of the RFID reader device 410, with the phase θ_{RX}. In some examples, the reflected signal 426 is weaker (e.g., lower power) than the transmitted signal 422. In some examples, the reader device 410 may generate the transmitted signal as a 900 megahertz (MHz) signal with phase θ_{TX}, among various other frequencies.

In one illustrative example, the RFID reader device 410 can perform phase-based ranging (PBR) measurements based on determining a phase difference between the transmitted signal 422 and the reflected signal 426. For example, a PBR measurement can correspond to the phase difference θ_{RX}−θ_{TX} between the transmitted signal 422 and reflected signal 426 (respectively) at the RFID reader device 410. In some aspects, the RFID reader device 410 determines the phase difference θ_{RX}−θ_{TX} based on removing the relatively strong transmitted signal 422 from the relatively weak reflected signal 426, which may introduce a source of phase error to both the phase difference measurement and the PBR measurement.

In some aspects, the carrier phase may change based on propagation distance at carrier frequency f_{c}, and distance D can be determined as:

$$D ≅ \frac{1}{2} \cdot \frac{{θ}_{R X} - {θ}_{T X}}{2 π} \cdot \frac{c}{{f}_{c}} \qquad Eq . ( 1 )$$

In some examples, a fixed calibration may be needed to account for antennas and reflection in the particular RFID tag 442.

For a carrier frequency of f_{c}=900 MHZ, PBR performed according to Eq. (1) may be associated with a maximum range (e.g., a maximum value of D)) of λ/2=33 cm, which in some cases may be too small to perform basket content item inventory and/or other RFID PBR measurement implementations (e.g., which may be performed and/or correspond to longer distances and/or ranges).

In some cases, a plurality of PBR measurements can be performed between the RFID reader device 410 and each RFID tag 442 that is of interest or within range of the transmitted signal 422. In one illustrative example, a plurality of transmitted signals 422 can be generated and transmitted by the RFID reader device 410, where each transmitted signal uses a different frequency. A phase difference measurement can be determined for each pair of transmitted signal at a particular frequency and the corresponding reflected signal.

For example, FIG. 4B is a diagram illustrating a plot 480 of PBR-based distance estimation using a plurality of RFID phase measurements 485, in accordance with some examples. For example, each RFID phase measurement 485 can be a phase difference measurement, such as the phase difference measurement θ_{RX}−θ_{TX} between the transmitted signal 422 and reflected signal 426 of FIG. 4A for a particular frequency f_{c}. In some aspects, each RFID phase measurement 485 can be a phase difference measured between a transmitted and reflected signal at a different carrier frequency f_{c} of the transmitted signal. Each RFID phase measurement 485 of the plurality of RFID phase measurements 485 of FIG. 4B can correspond to signals between an RFID reader and particular RFID tag, such as the RFID reader device 410 and RFID tag 442 of FIG. 4A. In some cases, each phase difference measurement 485 can be determined for a frequency f_{c} that is a configured offset fₛ away from the adjacent phase difference measurements 485 made at (f_{c}+fₛ) and (f_{c}−fₛ).

In one illustrative example, PBR measurements can be performed to obtain the plurality of phase difference measurements 485 using a plurality of different transmitted signal carrier frequencies f_{c} for the transmitted signal 422 from the RFID reader device 410 of FIG. 4A. A PBR-based distance estimate can be determined based on the gradient (e.g., slope) of a best-fit line determined for the plurality of phase difference measurements 485. For example, the gradient m can be determined as:

$$m = \frac{- 4 π}{c} D \qquad Eq . ( 2 )$$

Here, D represents the PBR-based distance estimate between the RFID reader device 410 and the RFID tag 442.

In some examples, a variance of the estimated distance D can be determined as σ_{D}², where σ_{D}² is based on the gradient-error equation of the best-fit line for the gradient m, the phase noise variance σ_{∈}², the frequency spacing fₛ, and the number of uniformly-spaced samples N in the plurality of phase difference measurements 485:

$${σ}_{D}^{2} = \frac{3 {σ}_{ϵ}^{2} {c}^{2}}{4 {π}^{2} {f}_{s}^{2} ( {N}^{3} - N )} \qquad Eq . ( 3 )$$

The term σ_{∈} represents the total phase noise, which can comprise principal components: σ_{∈}²=σ_{∈G}²+σ_{∈V}².

For example, σ_{∈V}² can represent the phase noise variance due to the VCO oscillator, and may be a function of the reader radio (e.g., the RFID reader device 410 radio, such as Rx 416 and/or Tx 412) and any additional phase noise introduced by the tag (e.g., the RFID tag 442) and the signal cancellation.

The term σ_{∈G}² can represent the phase noise variance based on Gaussian noise. For example, for SNR_{dB} 10>dB, the Gaussian noise (e.g., SNR) can create an approximate phase noise σ_{∈G} according to:

$${σ}_{ϵ G} ≅ \sqrt{\frac{1}{2 \cdot SNR}} , where SNR = {10}^{\frac{S N {R}_{d B}}{10}} \qquad Eq . ( 4 )$$

In some aspects, based on averaging multiple samples N (e.g., multiple phase difference measurements, such as the plurality of phase difference measurements 485 of FIG. 4B), the Gaussian phase noise σ_{∈G} of Eq. (4) can be reduced. Reducing the Gaussian phase noise σ_{∈G} can reduce the variance of the PBR-based distance estimate D, with the variance given according to Eq. (3).

For example, in some aspects, PBR distance estimation can be performed based on analyzing the phase change in an RF carrier, where the phase change in the RF carrier is based on the distance between two radio antennas. The phase change of the RF carrier can be analyzed to measure and/or determine range. In one illustrative example, multiple phase measurements (e.g., phase difference measurements 485 of FIG. 4B) can be obtained, each at different respective carrier frequencies f_{c}.

The gradient, m, of a best-fit line through the unwrapped phases, against carrier frequency f_{c}, can be used as a good approximation to the distance D between the radios (e.g., between the RFID reader device 410 and the RFID tag 442 of FIG. 4A). For example, in the context of RFID, PBR distance estimation can be used to determine the distance (e.g., range) between an RFID reader device and a particular RFID tag. A single phase change can be measured by the RFID reader device, for example on a single carrier, by transmitting an RF carrier, with the RFID tag configured to backscatter the carrier modulated with a modulated tone (e.g., 1010101010, etc.). For instance, transmitting an RF carrier can correspond to the transmitted signal 422 transmitted by the RFID reader device 410 of FIG. 4A. The RFID tag backscattering the carrier modulated with a modulated tone can correspond to the reflected signal 426 from the RFID tag 442 of FIG. 4A.

For example, in RFID RAIN (e.g., Radio Frequency Identification Recognize, Action, Interact, Network), the transmitted signal 422 and reflected signal 426 can be implemented based on an RFID tag (e.g., the RFID tag 442 of FIG. 4A) responding to a Query command (e.g., transmitted by the RFID reader device 410 of FIG. 4A). In some aspects, the RFID reader device 410 (e.g., and Rx 416 thereof) can measure a single phase-difference from the modulated tone signal on either side of the DC carrier, to obtain an individual phase difference measurement 485 for a corresponding carrier frequency f_{c}.

The distance estimate D can be determined based on multiple phase difference measurements 485, as noted above. In some cases, multiple commands can be transmitted from the RFID reader device 410 to the RFID tag 442 (e.g., multiple Query transmissions). In some cases, a separate Query command (e.g., a separate transmitted signal 422) can be used for each phase difference measurement 485 at a corresponding carrier frequency f_{c}. In some aspects, the RFID reader device 410 can be configured to change the carrier frequency f_{c} of the transmitted signal 422 during the reading back of the modulated tone of the reflected signal 426 from the RFID tag 442. For instance, in examples where the RFID tag 442 is a passive RFID tag, the RFID tag 442 is not aware of the change in carrier frequency f_{c} and will continue to reflect the modulated tone with the newly adjusted RF carrier. In one illustrative example, the RFID reader device 410 can be configured to capture the reflected signal 426 from the RFID tag 442 that is responsive to the changing carrier frequency and/or RF carrier used for the transmitted signal 422. Based on storing information indicative of the respective time(s) when the RFID reader device 410 changed the carrier frequency for the transmitted signal 422, the RFID reader device 410 can be configured to extract or determine the relative phase difference information 485 for each frequency of interest associated with plotting the plurality of measurements 485 along the horizontal frequency axis of the plot 480 of FIG. 4B. In some aspects, the distance estimate D can be determined using a single message (e.g., transmitted signal 422, Query message with changing RF carrier, etc.) from the RFID reader device 410 to the RFID tag 442.

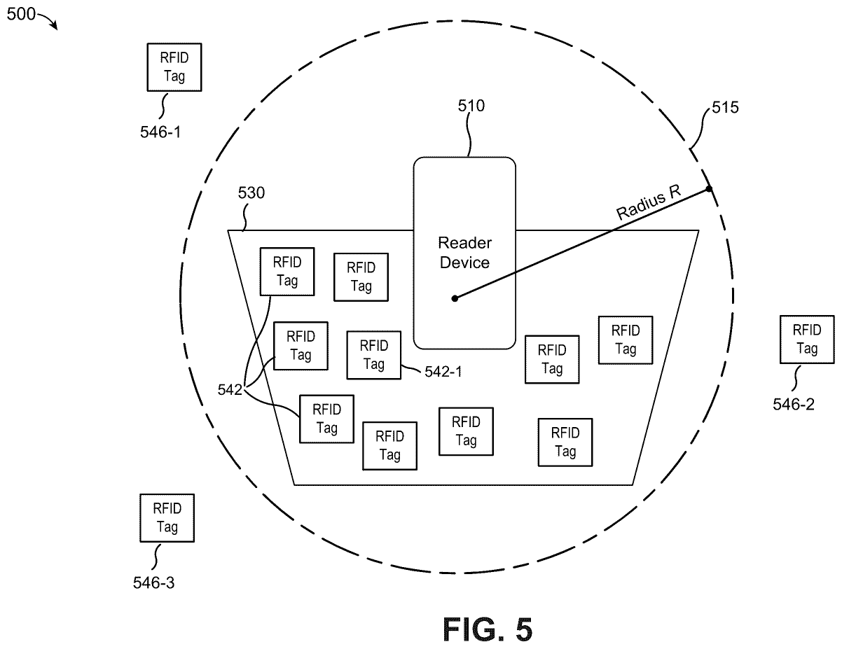

FIG. 5 is a diagram illustrating an example of an RFID system 500 that can be used to determine item inventory information using confidence-based RFID ranging. In one illustrative example, the RFID system 500 can determine item inventory information corresponding to the basket contents of a shopper or user of the RFID system 500, and may use a plurality of PBR measurements, RSSI measurements, and/or various combinations thereof.

In some aspects, an RFID reader device 510 (also referred to as a RFID reader or a scanner device) can be the same as or similar to the RFID reader device 410 of FIG. 4A, and may include one or more transmit antennas (e.g., the same as or similar to Tx 412 of FIG. 4A) and one or more receive antennas (e.g., the same as or similar to Rx 416 of FIG. 4A). In some cases, the RFID reader device 510 can be the same as or similar to the RFID reader 310 of FIG. 3.

In some cases, the RFID reader device 510 can be a smartphone, tablet computer, or other mobile computing device, etc., associated with a user. The RFID reader device 510 can be removably placed within a basket 530 or other volume of interest for the confidence-based RFID ranging and item inventory determination performed by the RFID system 500. In some aspects, the RFID reader device 510 may be permanently or semi-permanently coupled to the basket 530 or other volume of interest.

The user (e.g., shopper, etc.) can place various RFID tagged items within the basket 530, where each RFID tagged item is attached to and uniquely associated with a respective RFID tag 542. For example, each respective one of the RFID tags 542 can uniquely associate a particular RFID number with the item to which the RFID tag 542 is attached, etc. In some aspects, a first plurality of RFID tags 542 can be located within the basket 530. An item inventory determined for the contents of basket 530 can include the respective items associated with and/or attached to each respective RFID tag 542 included in the first plurality. A second plurality of RFID tags 546-1, 546-2, 546-3 (collectively referred to as second plurality of RFID tags RFID tags 546) can be located outside of the basket 530, and can correspond to items that are not located within the basket 530. The item inventory determined for the contents of basket 530 can exclude (e.g., not include) the respective items associated with and/or attached to each respective RFID tag included in the second plurality of RFID tags 546 (e.g., RFID tags 546-1, 546-2, 546-3, etc.). In some examples, the respective RFID tags of the first plurality 542 and/or the second plurality of RFID tags 546 (e.g., 546-1, 546-2, 546-3, etc.) can be the same as or similar to the RFID tag 350 of FIG. 3, the RFID tag 442 of FIG. 4A, etc.

In some aspects, the RFID reader 510 can be configured to generate and transmit an interrogating signal at a periodic interval and/or in response to a command or other configuration for generating and transmitting the interrogating signal. For example, the RFID reader 510 can generate and transmit a signal the same as or similar to the transmitted signal 422 of FIG. 4A. The signal from RFID reader 510 can be used to interrogate for nearby RFID tags (e.g., RFID tags within a read range and/or read zone of the RFID reader 510). The interrogation signal from RFID reader 510 can also be referred to as an energizing signal.

The RFID reader 510 can be associated with a shopper (e.g., user within a store or retail environment) and/or can be associated with the shopper's basket (e.g., a handheld basket, a pushcart, trolley, etc.). For instance, the RFID reader 510 (or a device including and/or implementing the RFID reader 510) can be placed on, within, or nearby to the shopper's basket. In some cases, the RFID reader 510 can be integrated with the basket and/or can be mounted on (e.g., attached to) the basket. In some cases, the RFID reader 510 can be configured as a smartphone or UE (e.g., of the shopper), etc., and may be located in proximity to the basket based on the smartphone or UE being carried by the shopper and the shopper being located in proximity to the basket. In some cases, a first RFID reader 510 can be included in or associated with the shopper's basket and a second RFID reader 510 can be associated with a consumer hand-held device (e.g., a handheld device carried by the shopper, such as a smartphone, UE, etc.).

The RFID reader 510 can include a transmitter for transmitting an energizing signal (e.g., interrogation signal) and can include a receiver for receiving a reflected signal indicative of identification information of a corresponding RFID tag (e.g., in examples where the corresponding RFID tag is a passive or semi-passive RFID tag that utilizes energy of the interrogation signal transmitted by the RFID reader 510 to transmit or reflect a backscatter signal indicative of the RFID tag identification information). The transmitter included in the RFID reader 510 can be the same as or similar to the transmitter 412 of FIG. 4A. The receiver included in the RFID reader 510 can be the same as or similar to the receiver 416 of FIG. 4A. In some examples, the RFID reader 510 can include an antenna or receiver for receiving the reflected signals and/or tag identification information from one or more RFID tags, and a transmitter configured to generate the energizing signal (e.g., interrogation signal) can be separate from the RFID reader 510. For example, an energizer may be located on the shopper's cart or basket, and the RFID reader 510 (e.g., RFID reader) may be configured as a read-only device integrated in or implemented by the shopper's handheld computing device. In another example, an energizer may be located within the aisles or mounted to the shelving units of a store or retail environment, and can be configured to transmit one or more energizing signals based on a proximity of one or more of the shopper, the shopper's basket, the shopper's RFID reader device, etc.

In one illustrative example, the RFID reader 510 can be used to energize and read one or more RFID tags within a read range and/or read zone of the RFID reader 510 and the energizing signal. For example, the RFID reader 510 can energize and read the one or more RFID tags 542 of the first plurality (e.g., within the basket 530) and/or the one or more RFID tags 546-1, 546-2, 546-3, etc., of the second plurality (e.g., not within the basket 530). In some aspects, some (or all) of the RFID tags of FIG. 5 can be implemented as passive RFID tags configured to reflect a backscatter signal indicative of the corresponding RFID tag identification information, where the backscatter signal is a reflected signal based on an energizing signal transmitted by the RFID reader 510.

RFID tags may be attached to corresponding items, products, objects, etc., within a store or other retail environment. The RFID tags may be applied at the time of manufacture of the items, during shipping or transportation of the items, at the time of stocking the items on the shelves of the store or retail environment, etc. Each RFID tag can be uniquely registered or mapped to an individual product or item within the store or retail environment. For instance, a mapping can be maintained between unique RFID tag identifiers and a corresponding product to which each RFID tag is affixed. In some examples, the RFID tag data storage element (e.g., such as data storage element 370 of FIG. 3) can be used to store unique identification information of a corresponding product to which the RFID tag is attached.

In some examples, the RFID reader 510 is configured to perform one or more measurement scans to interrogate and read nearby RFID tags. For instance, using the RFID reader 510 to perform a measurement scan can include transmitting interrogation signals (e.g., energizing signal, the transmitted signal 422 of FIG. 4A, etc.) to one or more (or all) of the RFID tags 546-1, 546-2, 546-3, etc., of the second plurality of RFID tags (e.g., also referred to as a “background noise” subset of RFID tags) and transmitting interrogation signals (e.g., energizing signal, the transmitted signal 422 of FIG. 4A, etc.) to one or more (or all) of the RFID tags 542 of the first plurality of RFID tags (e.g., also referred to as the basket contents or item inventory for basket 530).

In one illustrative example, the RFID system 500 and RFID reader device 510 can be used to perform a plurality of PBR measurements and/or RSSI measurements corresponding to signals transmitted by the RFID reader 510 and reflected by the respective RFID tags 542 (e.g., of the first plurality, located within the basket 530) and/or the respective RFID tags 546 (e.g., of the second plurality, located outside of the basket 530). Based on a set of PBR measurements and/or RSSI measurements determined by the RFID reader 510 for each respective RFID tag within read range, the systems and techniques can determine item inventory information indicative of the contents (e.g., the item inventory) of the user's basket 530, at various points in time. For example, the basket 530 item inventory information can be determined while a customer (e.g., user) shops in a store or other retail environment, and periodically or occasionally places or removes RFID tagged items into or from (respectively) the basket 530.

In one illustrative example, the RFID reader 510 can be configured to perform one or more RFID measurements with each respective RFID tag of a plurality of RFID tags, to thereby determine a corresponding distance estimate between the RFID reader 510 and the respective RFID tag. As used herein, “RFID measurements” may refer to PBR measurements associated with PBR-based distance estimation and/or RSSI measurements associated with RSSI-based distance estimation.

In some aspects, the RFID reader 510 can be configured to compare the distance estimate for each RFID tag (e.g., each RFID tagged item) to a configured threshold distance R. For example, the configured threshold distance R can correspond to the volume of the basket 530 and/or the relative location or position of the RFID reader 510 within the basket 530. In one illustrative example, the threshold distance R can be configured as the radius of a circle or sphere 515 that includes the volume of the basket 530, where RFID tagged items identified at an estimated distance less than or equal to the configured threshold distance R are included in the item inventory for the contents of basket 530, and RFID tagged items identified at an estimated distance greater than the configured threshold distance R are not included in the item inventory for the contents of basket 530. For example, the RFID reader 510 can be configured with a threshold distance R corresponding to an area or volume 515 the interior of which contains the RFID tagged items to be included in the basket 530 contents inventory information, and the exterior of which contains the RFID tagged items to be excluded from the basket 530 contents inventory information.

For example, the RFID reader 510 can perform a plurality of RFID measurements (e.g., PBR measurements and/or RSSI measurements, etc.) with each RFID tag of the first plurality 542 and may determine a distance estimate that is less than or equal to the configured threshold distance R. Based on each RFID tag 542 being associated with a distance estimate less than R, the corresponding RFID tagged items for the RFID tags 542 can be included in the item inventory information of the contents of basket 530. In some examples, for each RFID tag within range of the RFID reader 510 (e.g., the first plurality of RFID tags 542, the second plurality of RFID tags 546-1, 546-2, 546-3, etc.), the RFID reader 510 can perform a plurality of RFID measurements that are the same as or similar to the plurality of PBR phase difference measurements 485 of FIG. 4B. For example, the RFID reader 510 can determine phase difference measurements 485 at a plurality of different carrier frequencies f_{c} for each RFID tag of FIG. 5, and can determine a PBR-based distance estimate for each RFID tag based on the gradient of the best-fit slope for each set of phase different measurements 485 corresponding to a particular RFID tag (e.g., where the PBR-based distance estimate can be the same as or similar to the distance D of Eq. (2)).

In some aspects, the RFID reader 510 can determine confidence information for the respective distance estimate determined for each respective RFID tag of the plurality of RFID tags of FIG. 5. For example, respective confidence information can be determined for each PBR-based distance estimate between the RFID reader 510 and a respective RFID tag and/or for each RSSI-based distance estimate between the RFID reader 510 and a respective RFID tag. In some cases, the confidence information indicative of a probability distribution corresponding to the distance or range between the RFID reader 510 and a respective RFID tag of the plurality of RFID tags of FIG. 5. In some cases, the confidence information can be indicative of a maximum estimated distance and a minimum estimated distance between the RFID reader 510 and the respective RFID tag. The confidence information may be indicative of corresponding probabilities of the distance between the RFID reader 510 and respective RFID tag being less than, greater than, or equal to various values between the maximum and minimum estimated distances. In some cases, the confidence information can be indicative of corresponding probabilities of the distance between the RFID reader 510 and respective RFID tag being inside of or outside of a configured range of distance values, where the configured range of distance values comprises a subset within (e.g., between) the maximum and minimum estimated distances.

In one illustrative example, when the RFID reader 510 performs PBR distance estimation to the various RFID tags of FIG. 5, the confidence information corresponding to each respective PBR-based distance estimate can be based on a determined variance of the estimated distance D to the RFID tag. For example, the confidence information can comprise a variance of the PBR-based distance estimate D, according to Eq. (3) above. In some aspects, the confidence information can correspond to a total phase noise associated with the RFID measurements (e.g., PBR measurements) performed between the RFID reader 510 and a particular RFID tag. For example, the confidence information can correspond to a total phase noise that is the same as or similar to the total phase noise σ_{∈} of Eq. (3), where σ_{∈} represents the total phase noise, which can comprise principal components: σ_{∈}²=σ_{∈G}²+σ_{∈V}². In some aspects, the confidence information for a PBR-based distance estimate/) between the RFID reader 510 and a particular RFID tag can correspond to the oscillator-based phase noise variance σ_{∈V}² of Eq. (3), the Gaussian noise-based phase noise variance σ_{∈G}² of Eqs. (3) and (4), and/or can correspond to various combinations thereof.

In some aspects, the confidence information determined for the respective RFID tags can be compared to one or more configured thresholds. For example, the RFID reader 510 can perform a plurality of RFID measurements with a particular RFID tag of FIG. 5 to determine a distance estimate from the RFID reader 510 to the particular RFID tag, as noted above. The RFID reader 510 can additionally determine corresponding confidence information for the distance estimate to the particular RFID tag (e.g., variance information according to one or more of Eqs. (3) and/or (4)).

The confidence information for the distance estimate to each particular RFID tag can be compared to a configured confidence threshold. For example, if the confidence for the distance estimate to an RFID tag is greater than or equal to the configured confidence threshold, the distance estimate can be accepted and used to identify the RFID tag (and/or corresponding RFID tagged item associated with the RFID tag) as being included in the item inventory of the contents of basket 530, or as being not included in the item inventory of the contents of basket 530. If the confidence for the distance estimate to an RFID tag is less than the configured confidence threshold, the distance estimate may be rejected and the user can be prompted to move or reposition the reader device 510 within the basket 530, and the RFID measurements between the RFID reader 510 and the surrounding RFID tags can be repeated until the confidence for each distance estimate is greater than or equal to the configured confidence threshold.

In some aspects, repeating the distance estimation based on confidence values below the configured confidence threshold can include performing the distance estimation process for each RFID tag. In some examples, repeating the distance estimation can include performing the distance estimation for the subset of RFID tags that were previously identified as having a distance estimate confidence value below the configured confidence threshold.

In some examples, the confidence information can be used to repeat the RFID-ranging distance estimation until the confidence value for the distance estimate to each RFID tag within range of the RFID reader 510 is greater than or equal to the configured confidence threshold. In some cases, the confidence information can be used to repeat the RFID-ranging distance estimation until the confidence value for the distance estimate to each RFID tag determined to be within the configured distance R (e.g., each RFID tag identified as included in the item inventory of the basket 530 contents) is greater than or equal to the configured threshold. In some examples, different configured confidence threshold values can be used for RFID tags identified as being within the range R/included in the basket 530 contents and RFID tags identified as being outside of the range R/not included in the basket 530 contents.

For example, a first configured confidence threshold value can be used for the RFID tags with distance estimates within the distance R that will be included in the item inventory of the basket 530 contents, and a second configured confidence threshold value can be used for the RFID tags with distance estimates that are beyond the distance R and will not be included in the item inventory of the basket 530 contents. In one illustrative example, the first configured confidence threshold value can be greater than the second configured confidence threshold value (e.g., a higher or greater confidence may be used before including an RFID tagged item in the item inventory information for the basket 530 contents, and a relatively lower or smaller confidence may be used before not including an RFID tagged item in the item inventory information for the basket 530 contents, etc.).

In some aspects, the RFID reader 510 can be moved within the basket 530 based on determining one or more distance estimates that are below a configured confidence threshold. In some examples, the RFID reader 510 can be moved within the basket 530 and the RFID ranging measurements repeated until a configured percentage of RFID distance estimates are associated with a confidence metric greater than or equal to a configured confidence threshold value.

In some aspects, the determined item inventory information for the contents of basket 530 can be compared to and/or cross-referenced with shopping list information associated with the user (e.g., the user associated with the basket 530 and/or the RFID reader device 510). For example, the shopping list information of the user can be updated to indicate the subset of shopping list items that are currently determined to be included in the contents of basket 530 and to indicate the subset of shopping list items that are currently determined to not be included in the contents of basket 530. In some examples, the shopping list information of the user can be updated to indicate one or more items that are currently determined to be included in the contents of basket 530, but are not included in the shopping list information associated with or obtained for the user. In some examples, the item inventory information determined for the contents of basket 530 can be used to generate a running total or sub-total indicative of the cumulative purchase price of the various items that are identified as being currently located within the shopper's basket 530.

In one illustrative example, the determined item inventory information for the basket 530 contents can be displayed by a display of the reader device 510. For example, the reader device 510 can be configured to output and/or display information indicative of the RFID tagged items determined to be currently within the basket 530 (e.g., included in the item inventory information determined for the basket 530 contents, as described above), and/or can output or display the basket 530 item inventory information cross-referenced with the shopping list information of the user, as noted above. In some examples, the reader device 510 can be configured to output and/or display a cumulative total or sub-total corresponding to the total price for each item included in the determined item inventory information for the basket 530 contents. In some examples, a display of the RFID reader device 510 can be configured to output and/or display a subset of remaining items that are included in the user's shopping list information but are not included in the current (and/or most recently determined) item inventory of the basket 530 contents. In some aspects, the basket 530 can be a metal basket or volume that is enclosed on all sides with an open top (e.g., an open top through which the reader device 510 is placed or inserted within the volume of the basket 530, etc.). In some examples, a basket 530 having a metal construction can be configured as a Faraday cage that attenuates and/or partially attenuates RF signals from passing from the outside of the basket 530 to the inside of the basket 530. For example, the basket 530 can have a metal construction that acts as a Faraday cage to attenuate RFID ranging signals transmitted by the reader device 510 towards the RFID tag 546-3 and/or the RFID tag 546-2, without attenuating respective RFID ranging signals transmitted by the reader device 510 towards any of the RFID tags 542 that are located within the volume of the basket 530. In some cases, the open-top construction of the basket 530 may partially attenuate RFID ranging signals transmitted from the RFID reader device 510 towards the RFID tag 546-1.

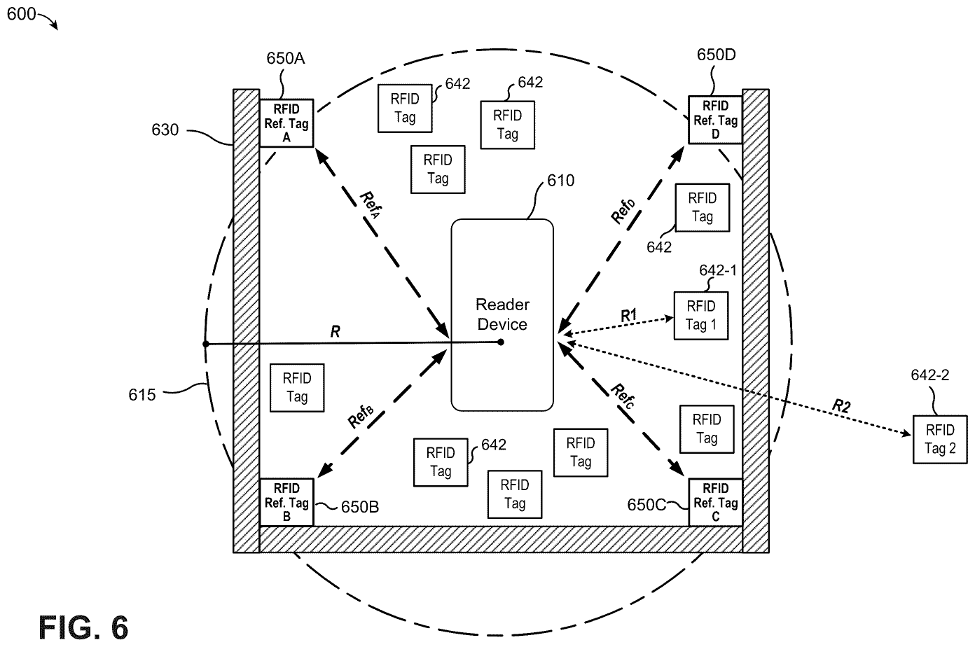

FIG. 6 is a diagram illustrating an example of an RFID system 600 that includes one or more reference RFID tags that can be used to perform selective RFID tag reading and/or basket contents item inventory estimation, in accordance with some examples. In some aspects, the RFID system 600 of FIG. 6 can be the same as or similar to the RFID system 500 of FIG. 5. For example, an RFID reader device 610 (also referred to as an RFID reader or reader device) of FIG. 6 can be the same as or similar to the RFID reader device 510 of FIG. 5. A basket 630 (e.g., volume of interest) of FIG. 6 can be the same as or similar to the basket 530 of FIG. 5. A first plurality of RFID tags 642 (e.g., included within the basket 630) of FIG. 6 can be the same as or similar to the first plurality of RFID tags 542 of FIG. 5. A second plurality of RFID tags can include the RFID tag 642-2 of FIG. 6 (e.g., not included within the basket 630), which can be the same as or similar to one or more of the RFID tags 546-1, 546-2, 546-3, etc., of FIG. 5.

In some examples, the one or more fixed reference tags 650A-650D can be used to improve the accuracy of the RFID distance estimation or ranging and/or the basket 630 content item inventory estimation performed by the RFID system 600 of FIG. 6. For example, a fixed reference tag can be implemented as an RFID tag attached to a known location on or within the shopper's basket (or other volume of interest for selective RFID tag reading). In one illustrative example, a plurality of RFID tags can be used as fixed references for a calibration process performed by the RFID reader before the RFID ranging-based basket content item inventory estimation. For example, a respective fixed reference RFID tag can be attached to one or more (or all) of the four bottom interior corners and/or four top interior of a shopper's basket.

In one illustrative example, the RFID system 600 can include one or more reference RFID tags each attached to a respective location on and/or within the basket 630. For example, the RFID system 600 can include a first RFID reference tag A 650A attached to an upper left corner of the basket 630, a second RFID reference tag B 650B attached to a lower left corner of the basket 630, a third RFID reference tag C 650C attached to a lower right corner of the basket 630, and a fourth RFID reference tag D 650D attached to an upper right corner of the basket 630. In some examples, the RFID reference tags 650A-650D can be the same as or similar to the RFID tags 642 and/or the RFID tag 642-2 of FIG. 6.

Calibration can be performed based on placing the RFID reader 610 (e.g., a smartphone, UE, or other mobile computing device associated with the user) within the basket 630, and performing a respective RFID ranging measurement between the RFID reader 610 and each one of the fixed reference RFID tags 650A-650D. For example, the RFID reader 610 can perform calibration based on a respective RFID ranging measurement with one or more (or all) of a front bottom left reference RFID tag, a front bottom right reference RFID tag, a back bottom left reference RFID tag, a back bottom right reference RFID tag, a front upper left reference RFID tag, a front upper right reference RFID tag, a back upper left reference RFID tag, and/or a back upper right reference RFID tag, etc.

In one illustrative example, the RFID reader 610 can perform a first RFID ranging and distance estimation Ref_{A} based on one or more RFID measurements (e.g., PBR measurements, RSSI measurements, etc.) between the RFID reader 610 and the first RFID reference tag 650A. The RFID reader 610 can perform a second RFID ranging and distance estimation Ref_{B} based on one or more RFID measurements (e.g., PBR measurements, RSSI measurements, etc.) between the RFID reader 610 and the second RFID reference tag 650B. The RFID reader 610 can perform a third RFID ranging and distance estimation Ref_{C} based on one or more RFID measurements (e.g., PBR measurements, RSSI measurements, etc.) between the RFID reader 610 and the third RFID reference tag 650C. The RFID reader 610 can perform a fourth RFID ranging and distance estimation Ref_{D} based on one or more RFID measurements (e.g., PBR measurements, RSSI measurements, etc.) between the RFID reader 610 and the fourth RFID reference tag 650D.

Based on the calibration RFID distance measurements (e.g., Ref_{A}, Ref_{B}, Ref_{C}, Ref_{D}) from the RFID reader 610 to the fixed reference RFID tags 650A-650-D (respectively) within the basket 630 volume, the RFID reader 610 can determine its relative three-dimensional (3D) location within the basket 630 and/or relative to the known and fixed reference point locations for the respective RFID reference tags 650A-650D. From the relative 3D location of the RFID reader 610 and/or the estimated distances from the RFID reader 610 to the respective RFID reference tags 650A-650D, the systems and techniques can determine a calibrated threshold distance R corresponding to the area or volume of the basket 630.

The calibrated threshold distance R of FIG. 6 can be the same as or similar to the configured threshold distance R of FIG. 5, and can correspond to an area or volume 615 (shown as a sphere) that encloses the volume of the basket 630, where an item within the basket 630 is also within the area or volume 615, and an item within the area or volume 615 is also within the basket 630. In some aspects, the calibration process performed between the RFID reader device 610 and the one or more RFID reference tags 650A-650D can be used to determine a calibrated threshold distance R that is guaranteed to be within the limits of the basket 630 and/or to enclose the interior of the basket 630 where the RFID tagged items and RFID tags 642 for the basket 630 item contents inventory may be located.

In some aspects, based on making range measurements to multiple reference tags (e.g., the range measurements Ref_{A}, Ref_{B}, Ref_{C}, Ref_{D} to the respective RFID reference tags 650A-650D), the RFID reader 610 can estimate its relative location to the RFID reference tags 650A-650D. Based on obtaining location information for each of the fixed RFID reference tags 650A-650D, and/or based on an assumption that an unknown location for the fixed RFID reference tags 650A-650D will be within the basket 630 and/or on the walls defining the maximum extent of the basket 630, the RFID reader 610 can perform calibration to determine the calibrated threshold distance R corresponding to the area or volume 615 that encloses the basket 630 contents.

In some cases, the RFID reader device 610 can be moved or repositioned within the basket 630 until the respective distances Ref_{A}-Ref_{D} from the RFID reader device 610 to the fixed RFID reference tags 650A-650D are approximately equal (e.g., the ranges to the fixed RFID reference tags 650A-650D are approximately centered, and the RFID reader 610 is approximately centered within the basket 630). In some aspects, using the RFID reference tags 650A-650D and respective ranges Ref_{A}-Ref_{D} to center the RFID reader 610 within the basket 630 can correspond to maximizing the limiting radius R (e.g., the calibrated threshold distance R used as the radius of the area or volume 615 enclosing the contents of basket 630). In some aspects, the RFID reader 610 can analyze the calibration ranges Ref_{A}-Ref_{D} to determine the minimum radius or calibrated threshold distance R guaranteed to be within the enclosed volume of the basket 630.

The calibrated threshold distance R can be subsequently compared to the respective distance estimate determined by the RFID reader 610 to each RFID tag of FIG. 6. The respective distance estimate to a particular RFID tag can be determined using PBR-based distance estimation and/or RSSI-based distance estimation, the same as or similar to that of FIG. 5.

In some aspects, RFID tags for which the respective distance estimate is determined to be less than or equal to the calibrated threshold distance R can be included in the item inventory information for the basket 630 contents. For example, the RFID reader 610 can determine a distance estimate R1 to the RFID tag 642-1 within the basket 630. Based on the distance estimate R1 for RFID tag 642-1 being less than the calibrated threshold distance R, the RFID reader 610 can determine that the RFID tag 642-1 is located within the basket 630 and should be included in the item inventory information for the basket 630 contents.

In another example, RFID tags for which the respective distance estimate is determined to be greater than the calibrated threshold distance R can be excluded from (e.g., not included in) the item inventory information for the basket 6y30 contents. For example, the RFID reader 610 can determine a distance estimate R2 to the RFID tag 642-2, which is located outside of the basket 630. Based on the distance estimate R2 for RFID tag 642-2 being greater than the calibrated threshold distance R, the RFID reader 610 can determine that the RFID tag 642-2 is not located within the basket 630 and should not be included in the item inventory information of the basket 630 contents.

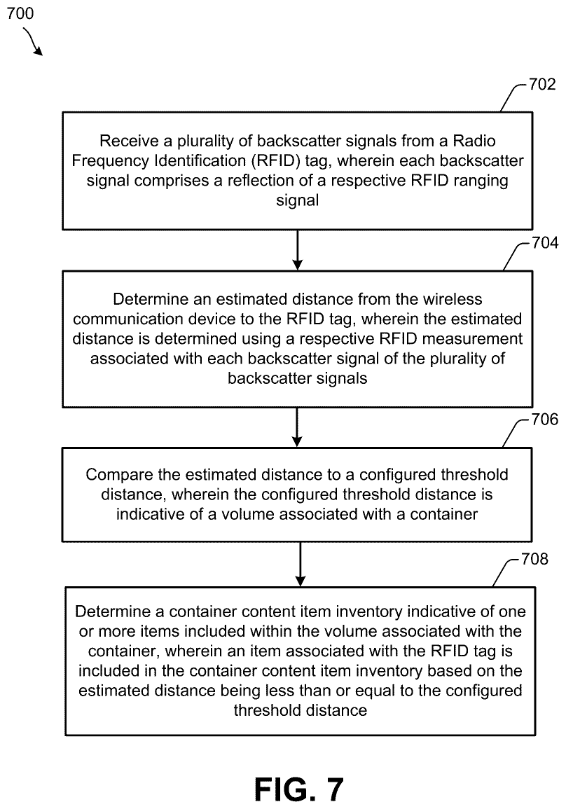

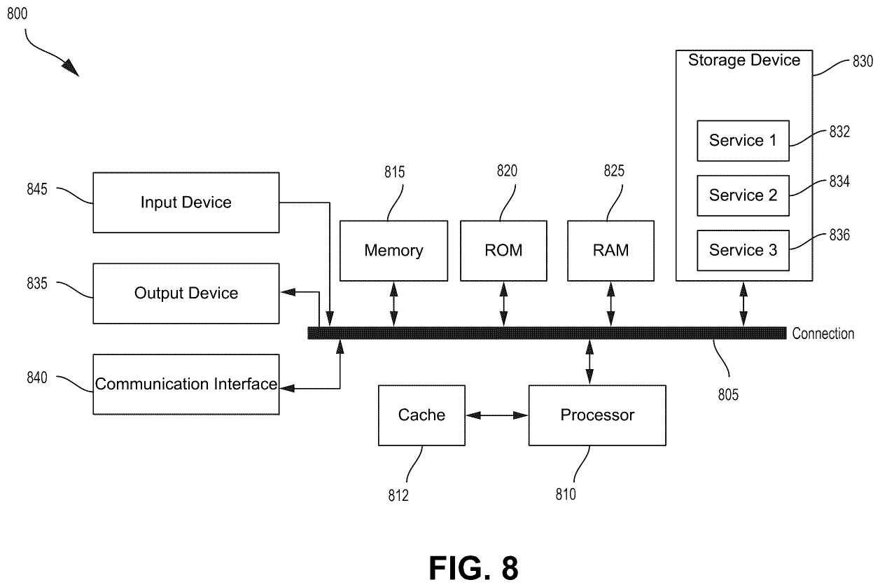

FIG. 7 is a flowchart diagram illustrating an example of a process 700 for wireless communications. In some examples, the process 700 can be performed by a computing device or apparatus or a component or system (e.g., one or more chipsets, one or more processors such as one or more CPUs, DSPs, NPUs, NSPs, microcontrollers, ASICS, FPGAs, programmable logic devices, discrete gates or transistor logic components, discrete hardware components, etc., any combination thereof, and/or other component or system) of the computing device or apparatus. The operations of the process 700 may be implemented as software components that are executed and run on one or more processors (e.g., processor 810 of FIG. 8 or other processor(s)). In some examples, the process 700 can be performed by an RFID reader and/or RFID energizer, such as the RFID reader 310 of FIG. 3, the RFID reader device 410 of FIG. 4A, the RFID reader device 510 of FIG. 5, and/or the RFID reader device 610 of FIG. 6, etc. In some aspects, the process 700 can be performed by a UE, smartphone, mobile computing device, user computer device, etc., that includes and/or implements an RFID reader (e.g., RFID energizer). In some examples, the process 700 can be performed by a computing device that includes an SoC configured to implement and/or including an RFID reader (e.g., RFID energizer). In some cases, the process 700 can be performed by an RFID reader (e.g., RFID energizer) included in or associated with a basket. For instance, the process 700 can be performed by an RFID reader included in or attached to a handheld shopping basket, cart, trolley, etc.

At block 702, the computing device (or component thereof) can receive a plurality of backscatter signals from a Radio Frequency Identification (RFID) tag, wherein each backscatter signal comprises a reflection of a respective RFID ranging signal.

For example, the computing device can be an RFID reader device configured to transmit and receive RFID signals (e.g., the respective RFID ranging signals). In some cases, the computing device can be an RFID reader device configured to transmit the respective RFID ranging signal associated with each backscatter signal of the plurality of backscatter signals, and to receive each backscatter signal of the plurality of backscatter signals.

In some cases, the RFID tag can be the same as or similar to the RFID tag 350 of FIG. 3; the RFID tag 442 of FIG. 4A; one or more of the RFID tags 542, 542-1, 546-1, 546-2, 546-3 of FIG. 5; one or more of the RFID tags 650A-650D, 642, 642-1, 642-2, etc., of FIG. 6; etc.

In some examples, the computing device (or component thereof) can be configured to transmit the respective RFID ranging signal associated with each backscatter signal. For example, the computing device can be the same as or similar to the reader device 410 of FIG. 4A, and can use the transmitter 412 to transmit the respective RFID ranging signal as the transmitted signal 422 of FIG. 4A.

In some cases, each backscatter signal of the plurality of backscatter signals comprises a reflection of a respective RFID ranging signal associated with a different carrier frequency. For example, each backscatter signal of the plurality of backscatter signals can be the same as or similar to the reflected signal 426 of FIG. 4A, which comprises a reflection of the transmitted signal 422 (e.g., where the respective RFID ranging signal associated with a different carrier frequency can be the same as or similar to the transmitted signal 422 of FIG. 4A).

At block 704, the computing device (or component thereof) can determine an estimated distance from the wireless communication device to the RFID tag, wherein the estimated distance is determined using a respective RFID measurement associated with each backscatter signal of the plurality of backscatter signals.

For example, the estimated distance can be the same as or similar to the estimated distance D of FIG. 4A, and/or the estimated distance D determined as the slope or gradient m of FIG. 4B, etc. In some cases, the estimated distance can be the same as or similar to one or more of the estimated distances Ref_{A}, R, Ref_{B}, Ref_{C}, R1, R2, Ref_{D}, etc., of FIG. 6.

In some cases, the respective RFID measurement associated with each backscatter signal comprises a phase-based ranging (PBR) measurement indicative of a phase difference between each backscatter signal and the respective RFID ranging signal. In some cases, each backscatter signal of the plurality of backscatter signals comprises a reflection of a respective RFID ranging signal associated with a different carrier frequency, and the respective RFID measurement comprises a phase-based ranging (PBR) measurement indicative of a phase difference between the carrier frequency of the respective RFID ranging signal and a frequency of the reflection of the respective RFID ranging signal.

For example, the phase difference between each backscatter signal and the respective RFID ranging signal can be the same as or similar to the phase difference measurement 485 of FIG. 4B. In some examples, the respective RFID measurement associated with each backscatter signal can be a PBR measurement indicative of a phase difference the same as or similar to the RFID phase measurement 485 of FIG. 4B, corresponding to the phase difference measurement θ_{RX}−θ_{TX} between the transmitted signal 422 and reflected signal 426 of FIG. 4A for a particular frequency f_{c}. In some aspects, the respective RFID measurement can be a phase difference the same as or similar to the phase difference measurement 485 of FIG. 4B, measured between a transmitted and reflected signal at a different carrier frequency f_{c} of the transmitted signal. Each RFID phase difference measurement 485 of the plurality of RFID phase difference measurements 485 of FIG. 4B can correspond to signals between an RFID reader and particular RFID tag, such as the RFID reader device 410 and RFID tag 442 of FIG. 4A. In some cases, each phase difference (e.g., phase difference measurement 485 of FIG. 4B, etc.) can be determined for a frequency f_{c} that is a configured offset fₛ away from the adjacent phase difference measurements 485 made at (f_{c}+fₛ) and (f_{c}−fₛ).

In some cases, the computing device (or component thereof) (e.g., the RFID reader device 410 of FIG. 4A, etc.) can perform phase-based ranging (PBR) measurements based on determining a phase difference between the transmitted signal 422 and the reflected signal 426 of FIG. 4A. In some examples, a PBR measurement can correspond to the phase difference θ_{RX}−θ_{TX} between the transmitted signal 422 and reflected signal 426 (respectively) at the RFID reader device 410. In some aspects, the RFID reader device 410 determines the phase difference θ_{RX}−θ_{TX} based on removing the relatively strong transmitted signal 422 from the relatively weak reflected signal 426, which may introduce a source of phase error to both the phase difference measurement and the PBR measurement.

In some examples, the respective RFID measurement associated with each backscatter signal comprises a Received Signal Strength Indicator (RSSI) measurement indicative of a signal power of the reflection of the respective RFID ranging signal received by the wireless communication device as the backscatter signal.

At block 706, the computing device (or component thereof) can compare the estimated distance to a configured threshold distance, wherein the configured threshold distance is indicative of a volume associated with a container.

For example, the container may be the same as or similar to the container 530 of FIG. 5, the basket 630 of FIG. 6, etc. In some examples, the container can be a shopper's basket, and the computing device (or component thereof) can be used to perform selective reading of RFID tags and RFID tag identification information corresponding to collected items of the container (e.g., shopper's basket, etc.). In some cases, the computing device (or component thereof) can perform selective RFID tag reading to determine, generate, and/or update item inventory information corresponding to the selectively read RFID tags. In one illustrative example, the item inventory information of selectively read RFID tags can correspond to RFID tagged items that are within the container (e.g., the shopper's basket).

In some examples, the volume associated with a container can be a volume associated with the container 530 of FIG. 5 (e.g., the same as or similar to the volume 515 with radius R of FIG. 5) and/or a volume associated with the basket 630 of FIG. 6 (e.g., the volume 615 with radius R of FIG. 6, etc.). In some cases, a shoppers “basket” may be an illustrative example of a container. However, the systems and techniques also apply to any other type of container. A shopper's “basket” (or container) can refer to any receptacle or volume within which items are placed for temporary storage and/or transport (e.g., prior to purchase or other use). For example, a shopper's “basket” can include various implementations, such as a handheld-basket, a cart or trolley, a bag or satchel, etc. A shopper's “basket” or “basket contents” may also refer to the hand carry of one or more items by a shopper.

In some examples, the estimated distance can be compared to a configured threshold distance that is determined based on one or more of the volume associated with the container or a dimension of the volume associated with the container. For example, the estimated distance can be compared to a configured threshold distance comprising the radius R (e.g., dimension) of the volume 515 associated with the container 530 of FIG. 5, can be compared to a configured threshold distance comprising the radius R (e.g., dimension) of the volume 615 of the basket 630 of FIG. 6), etc.

In some cases, the computing device (or component thereof) can determine a calibrated threshold distance based on a respective plurality of RFID ranging measurements between the computing device and each RFID reference tag of a plurality of RFID reference tags attached to the container.

For example, the calibrated threshold distance can correspond to the radius R of the volume 615 of the basket 630 of FIG. 6, and may be determined based on a respective plurality of RFID ranging measurements between the reader device 610 of FIG. 6 and the plurality of RFID reference tags 650A-650D of FIG. 6. In some cases, the respective RFID ranging measurements of the plurality of RFID ranging measurements can be the same as or similar to the RFID ranging measurements Ref_{A}, Ref_{B}, Ref_{C}, Ref_{D}, etc., of FIG. 6. In some examples, the computing device (or component thereof) can use the calibrated threshold distance as the configured threshold distance.

In some examples, the computing device (or component thereof) can determine an estimated distance from the wireless communication device to each RFID reference tag based on the respective plurality of RFID ranging measurements between the wireless communication device and each RFID reference tag. For example, the estimated distance to can be the same as or similar to the estimated distances Ref_{A}, Ref_{B}, Ref_{C}, Ref_{D} from the reader device 610 of FIG. 6 to the RFID reference tags 650A-650D (respectively) of FIG. 6. The computing device (or component thereof) can subsequently determine a relative location of the wireless communication device (e.g., reader device 610 of FIG. 6) within the volume (e.g., volume 615 of FIG. 6) associated with the container (e.g., basket 630 of FIG. 6), wherein the relative location is based on the estimated distance to each RFID reference tag and respective position information associated with each RFID reference tag.

In some cases, the computing device (or component thereof) can be configured to determine a minimum value of the calibrated threshold distance based on the estimated distance to each RFID reference tag and the relative location of the wireless communication device within the volume associated with the container. For example, the minimum value of the calibrated threshold distance can be a minimum value guaranteed to be within the volume of the basket. In some cases, the minimum value of the calibrated threshold distance can be the same as or similar to the minimum radius or calibrated threshold distance R guaranteed to be within the enclosed volume of the basket 630 of FIG. 6, which can be determined based on the computing device (or component thereof) (e.g., RFID reader 6t10 of FIG. 6) analyzing the calibration ranges Ref_{A}-Ref_{D} to the RFID reference tags 650A-650D (respectively) of FIG. 6.

At block 708, the computing device (or component thereof) can determine a container content item inventory indicative of one or more items included within the volume associated with the container, wherein an item associated with the RFID tag is included in the container content item inventory based on the estimated distance being less than or equal to the configured threshold distance.

In some examples, to determine the container content item inventory, the computing device (or component thereof) can be configured to determine confidence information associated with the estimated distance from the computing device (e.g., RFID reader device) to the RFID tag. The computing device (or component thereof) can subsequently compare the confidence information to a configured confidence threshold value. In some examples, the item associated with the RFID tag can be included in the container content item inventory based on the confidence information being greater than or equal to the configured confidence threshold value.

In some examples, the computing device (or component thereof) can determine an updated estimated distance from the computing device to the RFID tag based on the confidence information being less than the configured confidence threshold value, wherein the updated estimated distance is determined based on a second plurality of backscatter signals received from the RFID tag. In some cases, the estimated distance is associated with a first position of the wireless communication device within the volume associated with the container, and the updated estimated distance is associated with a second position of the wireless communication device within the volume associated with the container, wherein the second position is different from the first position.

The network entity, network device, and/or the wireless communication device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of a device configured to perform the process 700 of FIG. 7 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 700 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a block diagram illustrating an example of a computing system 800, which may be employed by the disclosed systems and techniques. In particular, FIG. 8 illustrates an example of computing system 800, which can be, for example, any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that communicatively couples various system components including system memory 815, such as read-only memory (ROM) 820 and random-access memory (RAM) 825 to processor 810. Computing system 800 can include a cache 812 of high-speed memory connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more range sensors (e.g., LIDAR sensors, laser range finders, RF radars, ultrasonic sensors, and infrared (IR) sensors) configured to collect data and provide measurements to processor 810, whereby processor 810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A wireless communication device for wireless communications, the wireless communication device comprising: at least one memory; and at least one processor coupled to the at least one memory and configured to: receive a plurality of backscatter signals from a Radio Frequency Identification (RFID) tag, wherein each backscatter signal comprises a reflection of a respective RFID ranging signal; determine an estimated distance from the wireless communication device to the RFID tag, wherein the estimated distance is determined using a respective RFID measurement associated with each backscatter signal of the plurality of backscatter signals; compare the estimated distance to a configured threshold distance, wherein the configured threshold distance is indicative of a volume associated with a container; and determine a container content item inventory indicative of one or more items included within the volume associated with the container, wherein an item associated with the RFID tag is included in the container content item inventory based on the estimated distance being less than or equal to the configured threshold distance.

Aspect 2. The wireless communication device of Aspect 1, wherein, to determine the container content item inventory, the at least one processor is further configured to: determine confidence information associated with the estimated distance from the wireless communication device to the RFID tag; and compare the confidence information to a configured confidence threshold value.

Aspect 3. The wireless communication device of Aspect 2, wherein the item associated with the RFID tag is included in the container content item inventory based on the confidence information being greater than or equal to the configured confidence threshold value.

Aspect 4. The wireless communication device of any of Aspects 2 to 3, wherein the at least one processor is further configured to: determine an updated estimated distance from the wireless communication device to the RFID tag based on the confidence information being less than the configured confidence threshold value, wherein the updated estimated distance is determined based on a second plurality of backscatter signals received from the RFID tag.

Aspect 5. The wireless communication device of Aspect 4, wherein: the estimated distance is associated with a first position of the wireless communication device within the volume associated with the container; and the updated estimated distance is associated with a second position of the wireless communication device within the volume associated with the container, wherein the second position is different from the first position.

Aspect 6. The wireless communication device of any of Aspects 1 to 5, wherein the at least one processor is further configured to transmit the respective RFID ranging signal associated with each backscatter signal.

Aspect 7. The wireless communication device of any of Aspects 1 to 6, wherein: the respective RFID measurement associated with each backscatter signal comprises a phase-based ranging (PBR) measurement indicative of a phase difference between each backscatter signal and the respective RFID ranging signal.

Aspect 8. The wireless communication device of any of Aspects 1 to 7, wherein: each backscatter signal of the plurality of backscatter signals comprises a reflection of a respective RFID ranging signal associated with a different carrier frequency; and the respective RFID measurement comprises a phase-based ranging (PBR) measurement indicative of a phase difference between the carrier frequency of the respective RFID ranging signal and a frequency of the reflection of the respective RFID ranging signal.

Aspect 9. The wireless communication device of any of Aspects 1 to 8, wherein: the respective RFID measurement associated with each backscatter signal comprises a Received Signal Strength Indicator (RSSI) measurement indicative of a signal power of the reflection of the respective RFID ranging signal received by the wireless communication device as the backscatter signal.

Aspect 10. The wireless communication device of any of Aspects 1 to 9, wherein the configured threshold distance is determined based on one or more of the volume associated with the container or a dimension of the volume associated with the container.

Aspect 11. The wireless communication device of any of Aspects 1 to 10, wherein the one or more processors are further configured to: determine a calibrated threshold distance based on a respective plurality of RFID ranging measurements between the wireless communication device and each RFID reference tag of a plurality of RFID reference tags attached to the container; and use the calibrated threshold distance as the configured threshold distance.

Aspect 12. The wireless communication device of Aspect 11, wherein the one or more processors are further configured to: determine an estimated distance from the wireless communication device to each RFID reference tag based on the respective plurality of RFID ranging measurements between the wireless communication device and each RFID reference tag; and determine a relative location of the wireless communication device within the volume associated with the container, wherein the relative location is based on the estimated distance to each RFID reference tag and respective position information associated with each RFID reference tag.

Aspect 13. The wireless communication device of Aspect 12, wherein the one or more processors are configured to determine a minimum value of the calibrated threshold distance based on the estimated distance to each RFID reference tag and the relative location of the wireless communication device within the volume associated with the container.

Aspect 14. The wireless communication device of any of Aspects 1 to 13, wherein the wireless communication device comprises an RFID reader device configured to transmit and receive RFID signals.

Aspect 15. The wireless communication device of any of Aspects 1 to 14, wherein the wireless communication device comprises an RFID reader device configured to transmit the respective RFID ranging signal associated with each backscatter signal of the plurality of backscatter signals, and to receive each backscatter signal of the plurality of backscatter signals.

Aspect 16. The wireless communication device of any of Aspects 1 to 15, wherein the container comprises one or more of a basket, a cart, a trolley, a bag, a satchel, or a box.

Aspect 17. The wireless communication device of any of Aspects 1 to 16, wherein the container comprises an interior volume of one or more of a car, a vehicle, or an automobile.

Aspect 18. The wireless communication device of any of Aspects 1 to 17, wherein the at least one processor is further configured to: determine an external container content item inventory indicative of one or more items not included within the volume associated with the container, wherein an item associated with the RFID tag is included in the external container content item inventory and is not included in the container content item inventory based on the estimated distance being greater than the configured threshold distance.

Aspect 19. A method for wireless communications, the method comprising: receiving, by a wireless communication device, a plurality of backscatter signals from a Radio Frequency Identification (RFID) tag, wherein each backscatter signal comprises a reflection of a respective RFID ranging signal; determining an estimated distance from the wireless communication device to the RFID tag, wherein the estimated distance is determined using a respective RFID measurement associated with each backscatter signal of the plurality of backscatter signals; comparing the estimated distance to a configured threshold distance, wherein the configured threshold distance is indicative of a volume associated with a container; and determining a container content item inventory indicative of one or more items included within the volume associated with the container, wherein an item associated with the RFID tag is included in the container content item inventory based on the estimated distance being less than or equal to the configured threshold distance.

Aspect 20. The method of Aspect 19, wherein determining the container content item inventory includes: determining confidence information associated with the estimated distance from the wireless communication device to the RFID tag; and comparing the confidence information to a configured confidence threshold value.

Aspect 21. The method of Aspect 20, wherein the item associated with the RFID tag is included in the container content item inventory based on the confidence information being greater than or equal to the configured confidence threshold value.

Aspect 22. The method of any of Aspects 20 to 21, further comprising: determining an updated estimated distance from the wireless communication device to the RFID tag based on the confidence information being less than the configured confidence threshold value, wherein the updated estimated distance is determined based on a second plurality of backscatter signals received from the RFID tag.

Aspect 23. The method of Aspect 22, wherein: the estimated distance is associated with a first position of the wireless communication device within the volume associated with the container; and the updated estimated distance is associated with a second position of the wireless communication device within the volume associated with the container, wherein the second position is different from the first position.

Aspect 24. The method of any of Aspects 19 to 23, further comprising transmitting, by the wireless communication device, the respective RFID ranging signal associated with each backscatter signal.

Aspect 25. The method of any of Aspects 19 to 24, wherein: the respective RFID measurement associated with each backscatter signal comprises a phase-based ranging (PBR) measurement indicative of a phase difference between each backscatter signal and the respective RFID ranging signal.

Aspect 26. The method of any of Aspects 19 to 25, wherein: each backscatter signal of the plurality of backscatter signals comprises a reflection of a respective RFID ranging signal associated with a different carrier frequency; and the respective RFID measurement comprises a phase-based ranging (PBR) measurement indicative of a phase difference between the carrier frequency of the respective RFID ranging signal and a frequency of the reflection of the respective RFID ranging signal.

Aspect 27. The method of any of Aspects 19 to 26, wherein: the respective RFID measurement associated with each backscatter signal comprises a Received Signal Strength Indicator (RSSI) measurement indicative of a signal power of the reflection of the respective RFID ranging signal received by the wireless communication device as the backscatter signal.

Aspect 28. The method of any of Aspects 19 to 27, wherein the configured threshold distance is determined based on one or more of the volume associated with the container or a dimension of the volume associated with the container.

Aspect 29. The method of any of Aspects 19 to 28, further comprising: determining a calibrated threshold distance based on a respective plurality of RFID ranging measurements between the wireless communication device and each RFID reference tag of a plurality of RFID reference tags attached to the container; and using the calibrated threshold distance as the configured threshold distance.

Aspect 30. The method of Aspect 29, further comprising: determining an estimated distance from the wireless communication device to each RFID reference tag based on the respective plurality of RFID ranging measurements between the wireless communication device and each RFID reference tag; and determining a relative location of the wireless communication device within the volume associated with the container, wherein the relative location is based on the estimated distance to each RFID reference tag and respective position information associated with each RFID reference tag.

Aspect 31. The method of Aspect 30, further comprising determining a minimum value of the calibrated threshold distance based on the estimated distance to each RFID reference tag and the relative location of the wireless communication device within the volume associated with the container.

Aspect 32. The method of any of Aspects 19 to 31, wherein the wireless communication device comprises an RFID reader device configured to transmit and receive RFID signals.

Aspect 33. The method of any of Aspects 19 to 32, wherein the wireless communication device comprises an RFID reader device configured to transmit the respective RFID ranging signal associated with each backscatter signal of the plurality of backscatter signals, and to receive each backscatter signal of the plurality of backscatter signals.

Aspect 34. The method of any of Aspects 16 to 33, wherein the container comprises one or more of a basket, a cart, a trolley, a bag, a satchel, or a box.

Aspect 35. The method of any of Aspects 16 to 34, wherein the container comprises an interior volume of one or more of a car, a vehicle, or an automobile.

Aspect 36. The method of any of Aspects 16 to 35, further comprising: determining an external container content item inventory indicative of one or more items not included within the volume associated with the container, wherein an item associated with the RFID tag is included in the external container content item inventory and is not included in the container content item inventory based on the estimated distance being greater than the configured threshold distance.

Aspect 37. A non-transitory computer-readable storage medium comprising instructions stored thereon which, when executed by at least one processor, causes the at least one processor to perform operations according to any of Aspects 1 to 18.

Aspect 38. A non-transitory computer-readable storage medium comprising instructions stored thereon which, when executed by at least one processor, causes the at least one processor to perform operations according to any of Aspects 19 to 36.

Aspect 39. An apparatus for wireless communication comprising one or more means for performing operations according to any of Aspects 1 to 18.

Aspect 40. An apparatus for wireless communication comprising one or more means for performing operations according to any of Aspects 19 to 36.

What is claimed is:

1. A wireless communication device for wireless communications, the wireless communication device comprising:
at least one memory; and
at least one processor coupled to the at least one memory and configured to:
receive a plurality of backscatter signals from a Radio Frequency Identification (RFID) tag, wherein each backscatter signal comprises a reflection of a respective RFID ranging signal;
determine an estimated distance from the wireless communication device to the RFID tag, wherein the estimated distance is determined using a respective RFID measurement associated with each backscatter signal of the plurality of backscatter signals;
compare the estimated distance to a configured threshold distance, wherein the configured threshold distance is indicative of a volume associated with a container; and
determine a container content item inventory indicative of one or more items included within the volume associated with the container, wherein an item associated with the RFID tag is included in the container content item inventory based on the estimated distance being less than or equal to the configured threshold distance.

2. The wireless communication device of claim 1, wherein, to determine the container content item inventory, the at least one processor is further configured to:
determine confidence information associated with the estimated distance from the wireless communication device to the RFID tag; and
compare the confidence information to a configured confidence threshold value.

3. The wireless communication device of claim 2, wherein the item associated with the RFID tag is included in the container content item inventory based on the confidence information being greater than or equal to the configured confidence threshold value.

4. The wireless communication device of claim 2, wherein the at least one processor is further configured to:
determine an updated estimated distance from the wireless communication device to the RFID tag based on the confidence information being less than the configured confidence threshold value, wherein the updated estimated distance is determined based on a second plurality of backscatter signals received from the RFID tag.

5. The wireless communication device of claim 4, wherein:
the estimated distance is associated with a first position of the wireless communication device within the volume associated with the container; and
the updated estimated distance is associated with a second position of the wireless communication device within the volume associated with the container, wherein the second position is different from the first position.

6. The wireless communication device of claim 1, wherein the at least one processor is further configured to transmit the respective RFID ranging signal associated with each backscatter signal.

7. The wireless communication device of claim 1, wherein:
the respective RFID measurement associated with each backscatter signal comprises a phase-based ranging (PBR) measurement indicative of a phase difference between each backscatter signal and the respective RFID ranging signal.

8. The wireless communication device of claim 1, wherein:
each backscatter signal of the plurality of backscatter signals comprises a reflection of a respective RFID ranging signal associated with a different carrier frequency; and
the respective RFID measurement comprises a phase-based ranging (PBR) measurement indicative of a phase difference between the carrier frequency of the respective RFID ranging signal and a frequency of the reflection of the respective RFID ranging signal.

9. The wireless communication device of claim 1, wherein:
the respective RFID measurement associated with each backscatter signal comprises a Received Signal Strength Indicator (RSSI) measurement indicative of a signal power of the reflection of the respective RFID ranging signal received by the wireless communication device as the backscatter signal.

10. The wireless communication device of claim 1, wherein the configured threshold distance is determined based on one or more of the volume associated with the container or a dimension of the volume associated with the container.

11. The wireless communication device of claim 1, wherein the one or more processors are further configured to:
determine a calibrated threshold distance based on a respective plurality of RFID ranging measurements between the wireless communication device and each RFID reference tag of a plurality of RFID reference tags attached to the container; and
use the calibrated threshold distance as the configured threshold distance.

12. The wireless communication device of claim 11, wherein the one or more processors are further configured to:
determine an estimated distance from the wireless communication device to each RFID reference tag based on the respective plurality of RFID ranging measurements between the wireless communication device and each RFID reference tag; and
determine a relative location of the wireless communication device within the volume associated with the container, wherein the relative location is based on the estimated distance to each RFID reference tag and respective position information associated with each RFID reference tag.

13. The wireless communication device of claim 12, wherein the one or more processors are configured to determine a minimum value of the calibrated threshold distance based on the estimated distance to each RFID reference tag and the relative location of the wireless communication device within the volume associated with the container.

14. The wireless communication device of claim 1, wherein the wireless communication device comprises an RFID reader device configured to transmit and receive RFID signals.

15. The wireless communication device of claim 1, wherein the wireless communication device comprises an RFID reader device configured to transmit the respective RFID ranging signal associated with each backscatter signal of the plurality of backscatter signals, and to receive each backscatter signal of the plurality of backscatter signals.

16. The wireless communication device of claim 1, wherein the container comprises one or more of a basket, a cart, a trolley, a bag, a satchel, or a box.

17. The wireless communication device of claim 1, wherein the container comprises an interior volume of one or more of a vehicle.

18. A method for wireless communications, the method comprising:
receiving, by a wireless communication device, a plurality of backscatter signals from a Radio Frequency Identification (RFID) tag, wherein each backscatter signal comprises a reflection of a respective RFID ranging signal;
determining an estimated distance from the wireless communication device to the RFID tag, wherein the estimated distance is determined using a respective RFID measurement associated with each backscatter signal of the plurality of backscatter signals;
comparing the estimated distance to a configured threshold distance, wherein the configured threshold distance is indicative of a volume associated with a container; and
determining a container content item inventory indicative of one or more items included within the volume associated with the container, wherein an item associated with the RFID tag is included in the container content item inventory based on the estimated distance being less than or equal to the configured threshold distance.

19. The method of claim 18, wherein determining the container content item inventory includes:
determining confidence information associated with the estimated distance from the wireless communication device to the RFID tag; and
comparing the confidence information to a configured confidence threshold value.

20. The method of claim 19, wherein the item associated with the RFID tag is included in the container content item inventory based on the confidence information being greater than or equal to the configured confidence threshold value.
